(19) United States
(12) Patent Application Publication
(10) Pub. No.: US 2026/0281427 A1
(43) Pub. Date: Sep. 17, 2026

(54) METHODS AND APPARATUSES FOR ENCODING AND DECODING AN IMAGE OR A VIDEO

(71) Applicant: InterDigital CE Patent Holdings, SAS, Paris (FR)

(72) Inventors: Gagan Bihari RATH, RENNES (FR); Fabrice LE LEANNEC, BETTON (FR); Ya CHEN, RENNES (FR); Thierry DUMAS, RENNES (FR)

(21) Appl. No.: 19/167,743

(22) PCT Filed: Mar. 26, 2024
(86) PCT No.: PCT/EP2024/058164

§ 371 Date: Sep. 22, 2025

(30) Foreign Application Priority Data
Mar. 31, 2023 (EP) 23305462.6
Apr. 12, 2023 (EP) 23305548.2

(51) Int. Cl. H04N 19/593; H04N 19/105; H04N 19/11; H04N 19/132; H04N 19/167; H04N 19/176; H04N 19/182

(52) U.S. Cl. CPC H04N 19/593; H04N 19/105; H04N 19/11; H04N 19/132; H04N 19/167; H04N 19/176; H04N 19/182

(57) ABSTRACT

A method and an apparatus for encoding or decoding a video are provided. A predictor block for a video block is obtained based on an angular intra prediction mode that uses at least one primary reference sample. The predictor block is modified using a position dependent pixel combination that uses for at least one pixel, a weighted combination of values determined from at least two secondary reference samples. The video block is encoded or decoded based at least on the modified predictor block.

This application claims the priority to European Application No. EP23305462.6, filed 31 Mar. 2023 and European Application No. EP23305548.2, filed 12 Apr. 2023, which are incorporated herein by reference in its entirety.

### TECHNICAL FIELD

The present embodiments generally relate to video compression. The present embodiments relate to a method and an apparatus for encoding or decoding an image or a video. More particularly, the present embodiments relate to improving intra prediction using position dependent pixel combination.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. In inter prediction, motion vectors used in motion compensation are often predicted from motion vector predictor. To reconstruct the video, the compressed data are decoded by inverse processes corresponding to the entropy coding, quantization, transform, and prediction.

### SUMMARY

According to an aspect, a method for encoding a video is provided. The method comprises obtaining a predictor block for a video block based on an angular intra prediction mode that uses at least one first primary reference sample for at least one pixel of the predictor block, modifying the predictor block using, for the at least one pixel of the predictor block, a weighted combination of values determined from at least two secondary reference samples, encoding the video block based at least on the modified predictor block.

According to another aspect, an apparatus for encoding a video is provided. The apparatus comprises one or more processors operable to obtain a predictor block for a video block based on an angular intra prediction mode that uses at least one first primary reference sample for at least one pixel of the predictor block, modify the predictor block using, for the at least one pixel of the predictor block, a weighted combination of values determined from at least two secondary reference samples, encode the video block based at least on the modified predictor block.

According to another aspect, a method for decoding a video is provided. The method comprises obtaining a predictor block for a video block based on an angular intra prediction mode that uses at least one first primary reference sample for at least one pixel of the predictor block, modifying the predictor block using, for the at least one pixel of the predictor block, a weighted combination of values determined from at least two secondary reference samples, decoding the video block based at least on the modified predictor block.

According to another aspect, an apparatus for decoding a video is provided. The apparatus comprises one or more processors operable to obtain a predictor block for a video block based on an angular intra prediction mode that uses at least first one primary reference sample for at least one pixel of the predictor block, modify the predictor block using, for the at least one pixel of the predictor block, a weighted combination of values determined from at least two secondary reference samples, decode the video block based at least on the modified predictor block.

Further embodiments that can be used alone or in combination are described herein.

One or more embodiments also provide a computer program comprising instructions which when executed by one or more processors cause the one or more processors to perform the method for encoding/decoding a video according to any of the embodiments described herein.

One or more of the present embodiments also provide a non-transitory computer readable medium and/or a computer readable storage medium having stored thereon instructions for encoding/decoding a video according to the methods described herein.

According to another aspect, a method for encoding or decoding a video is provided wherein the method comprises obtaining a prediction value for at least one pixel of a video block based on an intra prediction mode that uses at least one first primary reference sample, enabling or disabling a modification of the prediction value for the at least one pixel by at least one secondary reference sample, based on a distance of the at least one secondary reference sample to an origin of the video block, encoding or decoding the video block.

According to another aspect, a method for encoding or decoding a video is provided wherein the method comprises obtaining a prediction value for at least one pixel of a video block based on an intra prediction mode that uses at least one first primary reference sample, enabling or disabling a modification of the prediction value for the at least one pixel by at least one secondary reference sample, based on an availability of the at least one secondary reference sample, encoding or decoding the video block.

An apparatus that comprises one or more processors operable to implement the above methods is also provided.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIGS. 4A and 4B illustrate examples of angular intra prediction modes in VVC.

FIGS. 4C and 4D illustrate a relationship between the extent of the set of decoded reference samples surrounding a W×H block to be predicted and a range of allowed intra prediction angles.

FIG. 4E illustrates an example of angular modes replaced by wide-angular modes for a non-square block whose width is strictly larger than its height, in VVC and ECM.

FIG. 5 illustrates an example of the PDPC process in VVC or ECM wherein one secondary reference sample is used to modify the first predicted value for a positive prediction direction.

FIG. 6 illustrates an example of the gradient PDPC process in VVC or EMC wherein the secondary reference sample is on the left (top) reference array on the same row (column) as the target pixel, the gradient determined at the secondary reference sample being added to the first predicted value with a weight that is a decreasing function of the distance from the left (top) reference array.

FIG. 7 illustrates an example of a flowchart for determining whether normal PDPC or gradient PDPC is applied to a target block.

FIG. 8 illustrates an example of a flowchart of a method for encoding a video according to an embodiment.

FIG. 9 illustrates an example of a flowchart of a method for decoding a video according to an embodiment.

FIG. 10 illustrates an example of a unified PDPC process according to an embodiment, wherein two secondary reference samples are used: a secondary reference sample determined as in a “normal” PDPC and a secondary reference sample determined as in a gradient PDPC.

FIG. 11 illustrates an example of a unified PDPC process according to another embodiment when at least one of the secondary reference sample is not available.

FIG. 12 illustrates a block diagram of a system within which aspects of the present embodiments may be implemented, according to another embodiment.

FIG. 13 shows two remote devices communicating over a communication network in accordance with an example of the present principles.

FIG. 14 shows the syntax of a signal in accordance with an example of the present principles.

FIG. 15 illustrates an example of a template of a block to encode or decode and decoded reference samples for the template.

FIG. 16 illustrates an example for disabling PDPC according to an embodiment.

FIG. 17 illustrates an example for disabling PDPC according to another embodiment.

FIG. 18 illustrates an example of an adaptation of the set of reference samples of a template for a block to be predicted using a template-based intra prediction mode derivation according to an embodiment.

FIG. 19 illustrates another example of an adaptation of the set of reference samples of a template for a block to be predicted using a template-based intra prediction mode derivation according to an embodiment.

FIG. 20 illustrates an example of an adaptation of the set of reference samples of a template for a block to be predicted using a template-based intra prediction mode derivation according to an embodiment, when left part of the template is not available.

FIG. 21 illustrates an example of an adaptation of the set of reference samples of a template for a block to be predicted using a template-based intra prediction mode derivation according to an embodiment, when top part of the template is not available.

FIG. 22 illustrates an example of an adaptation of the set of reference samples of a template for a block to be predicted using a template-based intra prediction mode derivation according to another embodiment.

FIG. 23 illustrates an example of an adaptation of the set of reference samples of a template for a block to be predicted using a template-based intra prediction mode derivation according to another embodiment.

FIG. 24 illustrates an example of an adaptation of the set of reference samples of a template for a block to be predicted using a template-based intra prediction mode derivation according to another embodiment.

FIG. 25 illustrates an example of an adaptation of the set of reference samples of a template for a block to be predicted using a template-based intra prediction mode derivation according to another embodiment.

FIG. 26 illustrates an example of an adaptation of the set of reference samples of a template for a block to be predicted using a template-based intra prediction mode derivation according to another embodiment.

FIG. 27 illustrates an example of a method for encoding a video block according to an embodiment.

FIG. 28 illustrates an example of a method for decoding a video block according to an embodiment.

FIG. 29 illustrates an example of a method for template-based intra mode prediction derivation for encoding or decoding a video block according to an embodiment.

FIG. 30 illustrates an example of a method for template-based intra mode prediction derivation for encoding or decoding a video block according to another embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

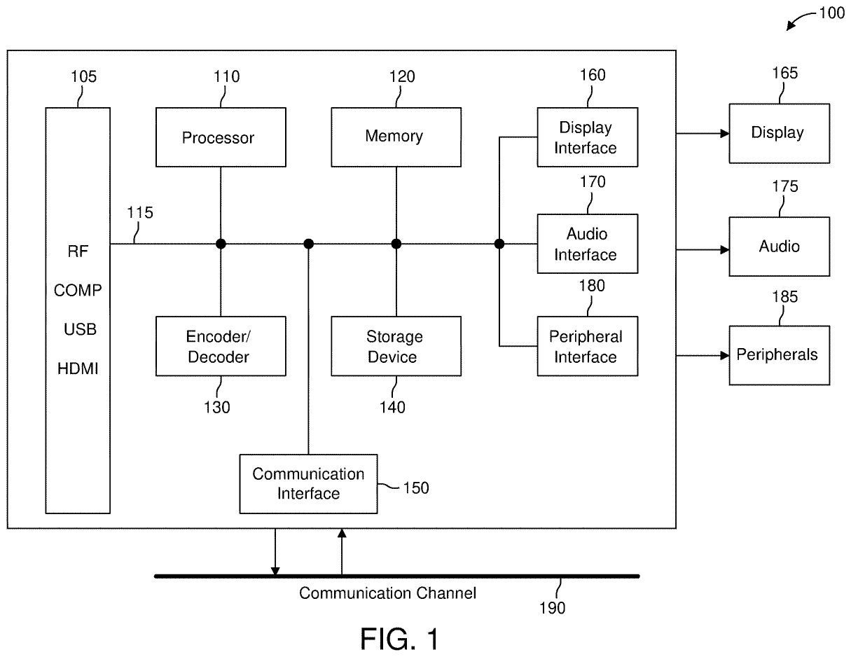

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, standard developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

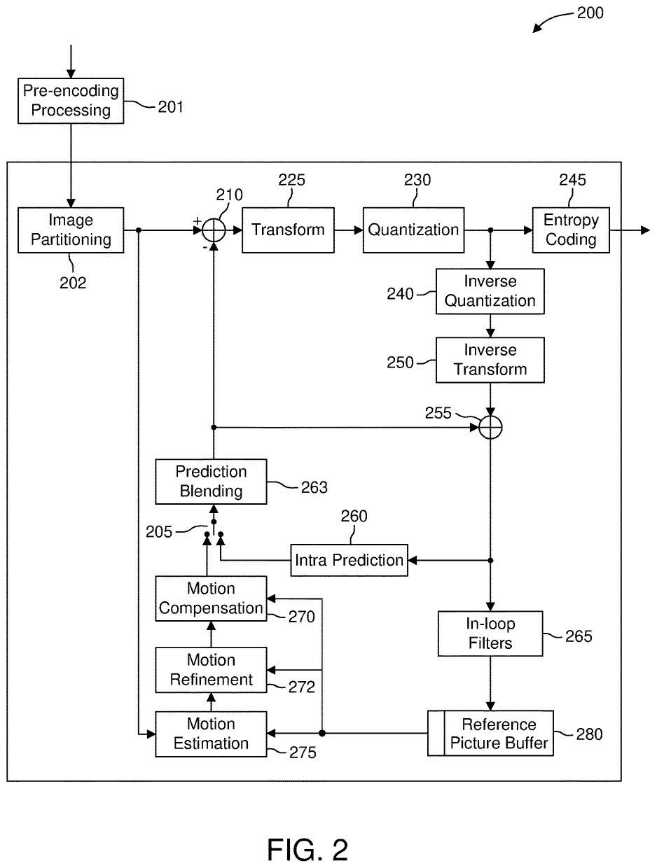

FIG. 2 illustrates a video encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder ECM under development by JVET (Joint Video Exploration Team). Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. In the disclosure, different expressions may be used to refer to such a unit or block resulting from a partitioning of the picture. Such wording may be coding unit or CU, coding block or CB, luminance CB, or block. A CTU (Coding Tree Unit) may refer to a group of blocks or group of units. In some embodiments, a CTU may be considered as a block, or a unit as itself.

Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

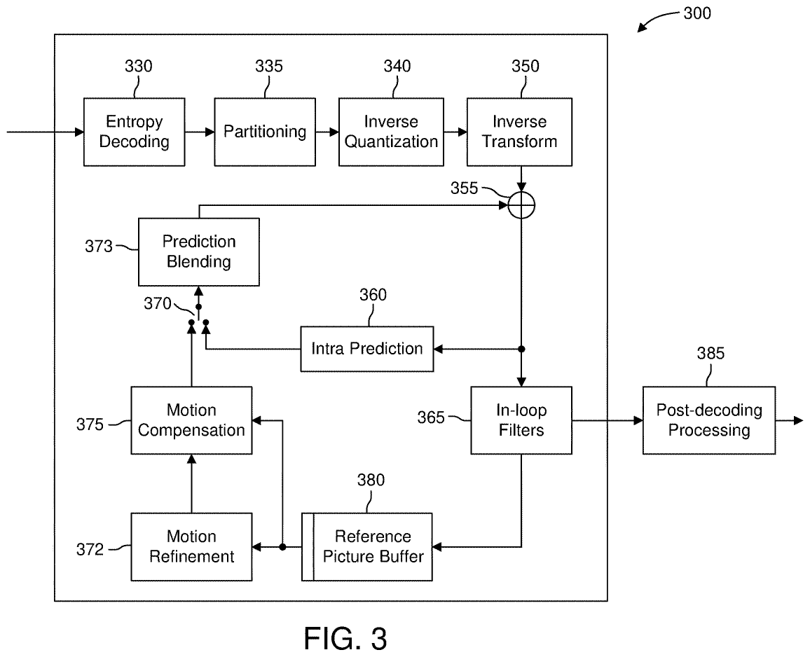

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

Embodiments described herein relates to intra prediction. Some of the embodiments relate to position dependent prediction combination used in intra prediction. Other embodiments relate to template-based intra mode derivation (TIMD).

It should be understood that any one of the embodiments described herein relating to position dependent prediction combination can be applied in any one of the embodiments described herein relating to template-based intra mode derivation (TIMD) and vice-versa.

Any one of the embodiments described herein can be implemented for instance in an intra prediction module 260 of the video encoder 200 or an intra prediction module 360 of the video decoder 300.

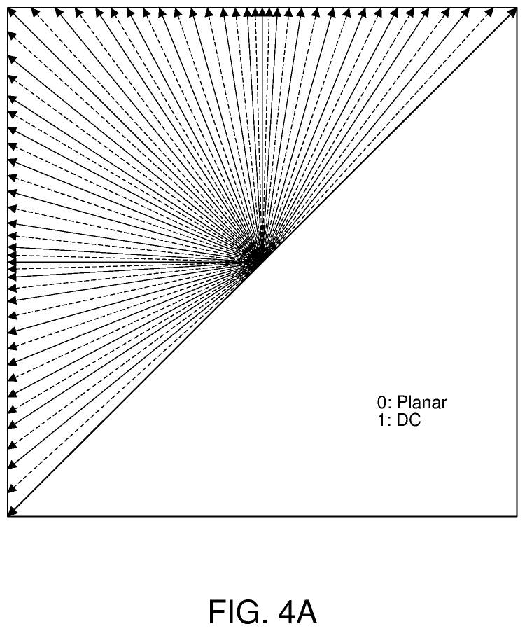

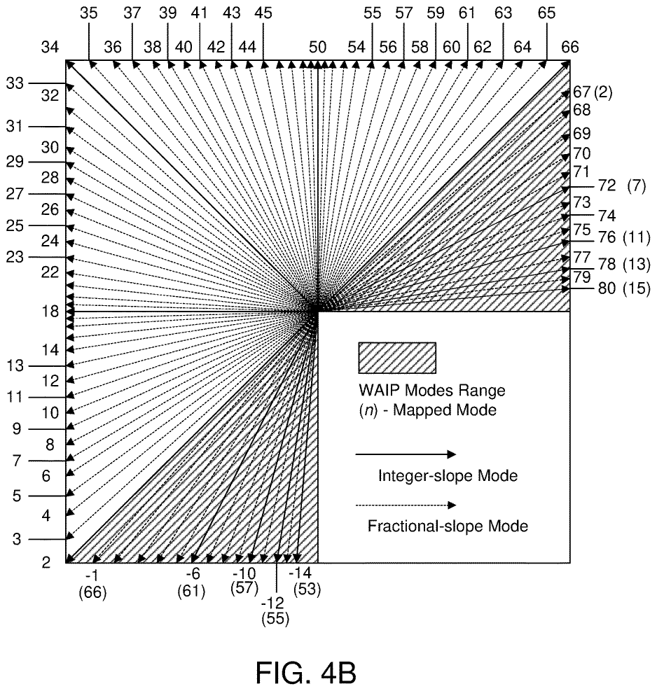

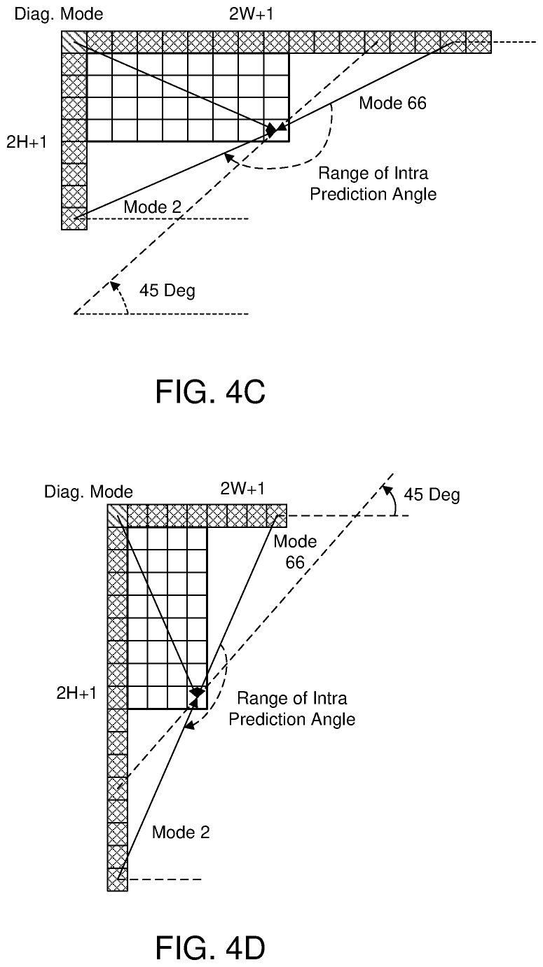

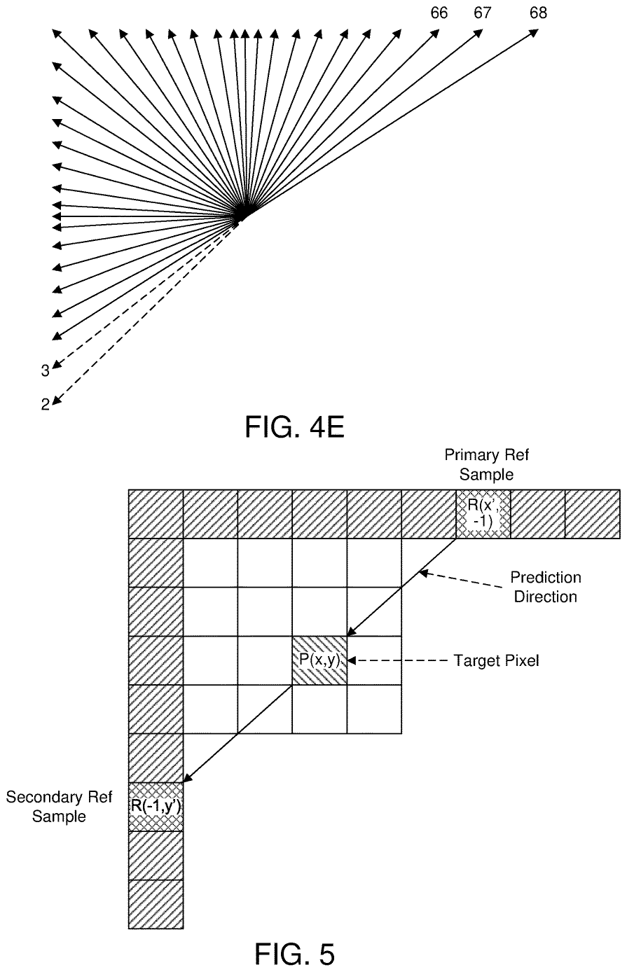

To capture the arbitrary edge directions presented in natural video, the number of directional intra prediction modes in VVC is extended from 33, as used in HEVC, to 65. The new directional modes not in HEVC are depicted as dotted arrows in FIG. 4A. These denser directional intra prediction modes apply for all block sizes and for both luma and chroma intra predictions. From HEVC to VVC, the planar mode and the DC mode remain unchanged, excluding the following minor modification. In HEVC, every intra-coded block has a square shape and the length of each of its side is a power of 2. Thus, no division operations are required to generate an intra-predictor using DC. In VVC, blocks can have a rectangular shape that necessitates the use of a division operation per block in the general case. To avoid division operations for DC prediction, only the longer side is used to compute the average for non-square blocks.

In ECM, the core structure of the 67 intra prediction modes is inherited from that in VVC. This core structure is refined in ECM as follows. The four-tap interpolation for a directional intra prediction mode from VVC becomes a six-tap interpolation and Position Dependent Intra Prediction Combination (PDPC) is supplemented with gradient PDPC.

In VVC and ECM, for non-square blocks, several conventional angular intra prediction modes are replaced with wide angular modes. The replaced modes are signaled using the original method and remapped to the indexes of wide angular modes after parsing. The total number of core intra prediction modes is unchanged, i.e., 67.

For the current W×H block to be predicted, FIGS. 4C and 4D illustrate the set of decoded reference samples, made of an array of top decoded reference samples of length 2 W+1 and an array of left decoded reference samples of length 2H+1. FIGS. 4C and 4D also show the relationship between the extent of the decoded reference samples around the current W×H block and the range of allowed intra prediction angles. Then, table a below presents an example of the indices of the intra prediction modes replaced by wide-angular modes in VVC and ECM, depending on the size of the current block to be predicted.

TABLE a
indices of the intra prediction modes replaced by wide-angular
modes in VVC and ECM (67 core intra prediction modes).

| condition | replaced intra prediction modes indices |
|---|---|
| W/H == 2 | 2, 3, 4, 5, 6, 7, 8, 9 |
| W/H == 4 | 2, 3, 4, 5, 6, 7, 8, 9, 10, 11 |
| W/H == 8 | 2, 3, 4, 5, 6, 7, 8, 9, 10, 11, 12, 13 |
| W/H == 16 | 2, 3, 4, 5, 6, 7, 8, 9, 10, 11, 12, 13, 14, 15 |
| W/H == 32 | 2, 3, 4, 5, 6, 7, 8, 9, 10, 11, 12, 13, 14, 15, 16 |
| W/H == 1 | none |
| H/W == 2 | 59, 60 61, 62, 63, 64, 65, 66 |
| H/W == 4 | 57, 58, 59, 60, 61, 62, 63, 64, 65, 66 |
| H/W == 8 | 55, 56, 57, 58, 59, 60, 61, 62, 63, 64, 65, 66 |
| H/W == 16 | 53, 54, 55, 56, 57, 58, 59, 60, 61, 62, 63, 64, 65, 66 |
| H/W == 32 | 52, 53, 54, 55, 56, 57, 58, 59, 60, 61, 62, 63, 64, 65, 66 |

FIG. 4E shows an example of how angular intra modes are replaced by wide angular modes for a non-square block whose width is strictly larger than its height. In this example, mode 2 is replaced by wide angle mode 67. Mode 3 is replaced by wide angle mode 68. For instance, if the current block to be predicted is 8×4, this process of substitution will go on incrementally until mode 7 is replaced by wide angle mode 72.

A current block to encode/decode can be predicted using template-based intra mode derivation (TIMD). TIMD derives one or two intra prediction modes for the current block from a template of the current block. For the current block to be encoded/decoded, TIMD follows a two-step process: an intra prediction mode index derivation step involving a template of decoded reference samples of the current block and a step in which the current block is actually predicted.

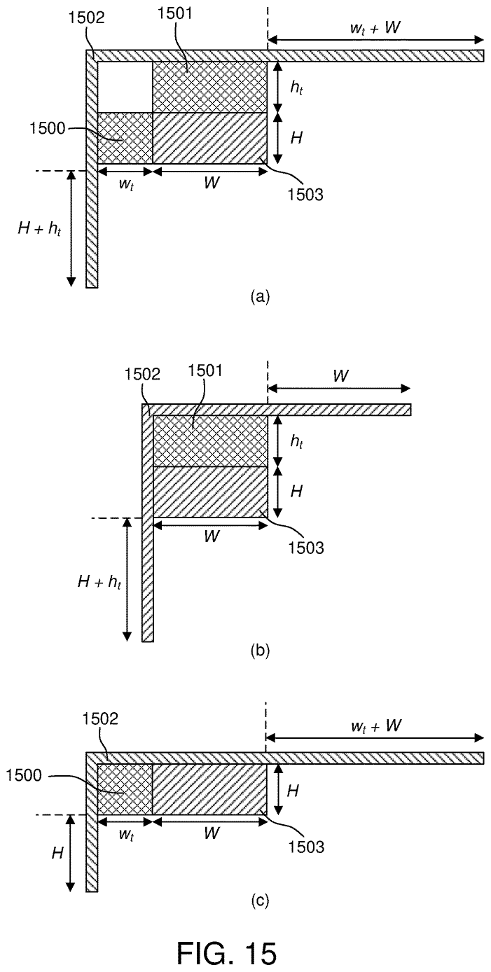

More precisely, for a given block, (1503) in FIG. 15 (a), the following intra prediction modes derivation via TIMD applies the same way on the encoder and decoder sides. For each intra prediction mode in the MPM (Most Probable Modes) list of this block, if needed, supplemented with default modes, the TIMD determines a prediction of the template (1500 and 1501) of this block from the decoded reference samples of the template (1502), and the SATD between this prediction and the template of this block is calculated. The two intra prediction modes with the minimum SATDs are selected as the TIMD modes. Note that, for TIMD, the set of directional intra prediction modes is extended from 65 to 129, by inserting a direction between each plain black arrow and its neighboring dashed arrow in FIG. 4A. This means that the set of possible intra prediction modes derived via TIMD gathers 131 modes. After retaining two intra prediction modes from the first pass of tests involving the MPM list supplemented with default modes, for each of these two modes, if this mode is neither PLANAR nor DC, TIMD also tests in terms of prediction SATD its two closest extended directional intra prediction modes. Note that, above, it is assumed that the template of the block does not go out of the bounds of the current frame. In the case where at least one portion of the template of the block goes out of the bounds of the current frame, the template (1501, 1500) of the block (1503) and reference samples (1502) used to predict the template are modified as illustrated in FIG. 15 (b) and 15(c).

To predict the current block via TIMD, the two predictions of the block via the two TIMD modes (Mode-1 and Mode-2) resulting from the two passes of tests are fused with weights after applying PDPC. The used weights depend on the prediction SATDs (costMode1, costMode2) of the two TIMD modes.

Position dependent intra prediction combination (PDPC) is included in the derivation of the TIMD modes. Therefore, any one of the embodiments described herein that applies to PDPC can also be used when applying PDPC in the derivation of the TIMD modes.

In ECM, the costs of the two selected modes (Mode-1 and Mode-2) are compared with a threshold, in the test the cost factor of 2 is applied as follows:
costMode2<2*costMode1, wherein costMode2 is the cost of the secondary intra prediction mode and costMode1 is the cost of the primary intra prediction mode.

If this condition is true, the fusion is applied, otherwise the only Mode-1 is used.

For example, weights of the modes are determined from their SATD costs as follows:

$$weight 1 = costMode 2 / ( costMode 1 + costMode 2 )$$

$$weight 2 = 1 - weight 1$$

As, for TIMD, the set of directional intra prediction modes is extended from 65 to 129, the intra prediction modes substitution in WAIP is adapted. Table a above becomes table b below. For instance, for a given 8×4 block using TIMD, mode 2 is replaced by wide angle mode 131, mode 3 is replaced by wide angle mode 132, mode 4 is replaced by wide angle mode 133, . . . , mode 12 is replaced by wide angle mode 141.

TABLE b
indices of the intra prediction modes replaced
by wide-angular modes in TIMD in ECM.

| | replaced intra prediction |
|---|---|
| condition | modes indices |
| W/H == 2 | [\|2, 12\|] |
| W/H == 4 | [\|2, 20\|] |
| W/H == 8 | [\|2, 24\|] |
| W/H == 16 | [\|2, 28\|] |
| W/H == 32 | [\|2, 30\|] |
| W/H == 1 | none |
| H/W == 2 | [\|120, 130\|] |
| H/W == 4 | [\|112, 130\|] |
| H/W == 8 | [\|108, 130\|] |
| H/W == 16 | [\|104, 130\|] |
| H/W == 32 | [\|102, 130\|] |

Position dependent pixel combination (PDPC) in VVC or ECM is a post processing tool in intra prediction. It aims at removing the discontinuities arising from the initial intra prediction for certain prediction modes at the target block boundaries adjacent to the reference samples. It achieves this by using a weighted combination of the initial prediction value and one or more nearby reference samples. Besides the two non-angular modes, that is, the PLANAR mode and the DC mode, it is also enabled in the case of purely horizontal and purely vertical modes and the angular modes in the directions from the bottom-left corner towards top-right corner of the block and vice versa. Depending on the prediction direction, either the normal PDPC or a gradient PDPC, is applied.

Intra prediction in VVC (“Versatile Video Coding (Draft 8)”, B. Bross, J. Chen, S. Liu, and Y.-K. Wang, JVET-02001-vD, JVET Meeting, January 2020, Brussels, Belgium) and ECM (“Algorithm description of Enhanced Compression Model 6 (ECM 6)”, M. Coban, F. Le Léannec, K. Naser, J. Ström, L. Zhang, JVET-AA2025, JVET Meeting, July 2022, Teleconference) includes position dependent pixel combination (PDPC) as a post-processing tool for certain prediction modes having the possibility of intensity discontinuities at the left or top of a target block. In particular, it is enabled in the case of PLANAR mode, DC mode, purely horizontal and purely vertical modes, and modes associated with directions from bottom left towards top right or vice versa.

PDPC is also used as a post-processing in the derivation process of intra prediction modes of the TIMD coding mode described above.

Application of the PDPC processing depends on the intra prediction mode as follows.

In the case of PLANAR and DC modes, PDPC is applied to the first predicted values at both top and left sides of the target block. In the case of purely vertical or purely horizontal modes, it is applied to the first predicted values, respectively, on the left or the top sides of the block. For other eligible angular modes, it is applied on either the left or the top side depending on if the mode is vertical or horizontal. The first predicted values on top rows or left columns are modified gracefully using weighted combinations with the reference samples on the top or the left side of the block respectively. Without PDPC the reconstructed frames can have blocking artifacts resulting from quantization of high frequency coefficients. Therefore, PDPC has been adopted in VVC and ECM.

For angular modes eligible for PDPC, the processing involves a weighted combination of the first predicted value with a secondary reference sample as illustrated in FIG. 5. With some modes, the secondary reference sample may not be available for some target pixels because of the finite length of the secondary reference array. In these cases, for the current block, the PDPC is replaced with a gradient PDPC (“Unified PDPC for Angular Intra Modes,” B. Ray, G. V. der Auwera, M. Karczewicz, JVET-0391, JVET Meeting, January 2020, Brussels, Belgium), as illustrated on FIG. 6, where a weighted value of the gradient value computed at the secondary reference sample on the same row (for vertical modes) or the same column (for horizontal modes) as the target pixel is added to the initial predicted value. These two cases are determined by computing a scale value from the prediction angle and the length of the secondary reference array. A negative scale value indicates that the length of the secondary reference array is not sufficient, and hence the gradient PDPC is enabled. The gradient PDPC is similar to the PDPC applied to the purely vertical or purely horizontal directions but the gradient is computed along the current prediction direction. Though the computation involved in the gradient PDPC is different from that in normal PDPC, they both have the same form and aim for the same goal.

VVC and ECM define 67 prediction modes for intra prediction of any target block. Out of these modes, 2 are non-angular (i.e., mode 0 namely the PLANAR mode, and mode 1 namely the DC mode) and the remaining 65 are angular modes, depicted on FIG. 4A. The modes are associated with prediction directions ranging from 45 degrees to −135 degrees in clockwise manner. Depending on the block shape, some angular modes are replaced with equal number of wide angular modes defined beyond the above range. Angular modes and wide-angular modes in VVC are illustrated on FIG. 4B.

The modes are termed horizontal if they refer to the directions below the diagonal direction (i.e., from top left towards bottom right), they are termed vertical otherwise. They are further referred to as positive or negative depending on which side of the purely horizontal (i.e., below or above purely horizontal) or purely vertical (i.e., to the right or left of the purely vertical) direction they belong to. Thus, the directions below and including purely horizontal, and to the right of and including purely vertical are referred to as positive directions. The remaining directions are referred to as negative directions. PDPC is enabled only for positive direction angular modes.

In the following, an example of the PDPC process is described for a positive vertical direction; it is analogous with a positive horizontal direction with the reference arrays interchanged, and the width and the height of the target block interchanged.

FIG. 5 illustrates the PDPC in intra prediction for a positive vertical direction for a target block of pixels shown in white on FIG. 5, grey squares showing reference samples, that is reconstructed neighboring samples. The coordinate (0,0) addresses the top-left sample within the block. For a target pixel at location (x,y) in the block, a first prediction P(x,y) is obtained from the top reference array at (x′,−1). Unless the prediction direction has integer slope, the reference sample is interpolated using a smoothing filter or a cubic interpolation filter. So, the predictor is estimated as

P(x,y)=R(x′,−1), where R(x,y) is the array of reconstructed neighboring samples. In the following the reconstructed neighboring samples used for obtaining the first prediction are referred as primary reference sample, while the reconstructed neighboring samples used in the PDPC process are referred as secondary reference samples. Primary reference samples are referred herein as the reference samples that are located in a primary reference array that used by the intra prediction mode to build a prediction for a target pixel. In the example of FIG. 5, the primary reference array is the top reference array (array of reconstructed samples on top of the target block). In case of a positive horizontal direction intra prediction, the primary reference array is the left reference array (array of reconstructed samples to the left of the target block).

Secondary reference samples are referred herein as the reference samples that are located in a secondary reference array. The secondary reference array is the array of reconstructed samples that is obtained by extending the angular prediction direction of the intra prediction mode beyond the target block. In the example of FIG. 5, the secondary reference array is the left reference array (array of reconstructed samples to the left of the target block). In case of a positive horizontal direction intra prediction, the secondary reference array is the top reference array (array of reconstructed samples on top of the target block).

In the PDPC process, the prediction direction is extended to obtain a secondary reference sample R(−1,y′) that intercepts the secondary boundary reference samples array, i.e. the left reference array in the case of vertical prediction direction. The secondary reference sample, for lower complexity, is chosen as the nearest neighbor when the extension does not pass through a reference sample position. If absInvAngle denotes inverse of the tangent of the angle value corresponding to the prediction direction, the y-coordinate y′ of the secondary reference sample is obtained as

y′=1+y+(((1+x)*absInvAngle+256)>>9), wherein >> represents binary right shift.

The first prediction value at (x,y) is modified as: P(x,y)=P(x,y)+(wL*(R(−1,y′)−P(x,y))+32)>>6, where the weight parameter wL is computed as wL=32>>(2*x>>scale), and the parameter scale is computed as:

$$scale = min ( 2 , Log 2 ( height ) - ( Log 2 ( 3 * absInvAngle - 2 ) - 8 ) ) ;$$

In this example, it is assumed that the scale parameter is a positive integer between 0 and 2. As the value of wL decreases to 0 with increasing x, the scale parameter determines the number of columns in the target block that are modified in the PDPC process. Since the maximum value of wL is 32, the number of columns undergoing PDPC is (3<<scale). Table 1 shows a number of columns used for PDPC and the corresponding values of wL for different scale parameter values.

TABLE 1
Number of columns or rows processed in PDPC and the corresponding
weights for predictions along positive vertical directions.
For positive horizontal directions, the number of columns
is replaced by the number of rows and wL(x) is replaced
by wL(y) for y = 0, 1, . . . (K-1).

| scale | Num Cols(K) | wL(x) for x = 0, 1, . . . (K-1) |
|---|---|---|
| 0 | 3 | 32, 8, 2 |
| 1 | 6 | 32, 16, 8, 4, 2, 1 |
| 2 | 12 | 32, 32, 16, 16, 8, |
| | | 8, 4, 4, 2, 2, 1, 1 |

As, in some cases, the number of columns can be greater than the target block width, the actual number of columns getting modified with PDPC is given as min((3<<scale), width).

In the case of prediction along positive horizontal directions, the process remains the same. A secondary reference sample R(x′,−1) is found by computing the coordinate x′ as

$$x ’ = 1 + x + ( ( ( 1 + y ) * absInvAngle + 256 ) >> 9 )$$

The first prediction value at (x,y) is modified as

P(x,y)=P(x,y)+(wL*(R(x′,−1)−P(x,y))+32)>>6, where the weight parameter wL is computed as wL=32>>(2*y>>scale) and the parameter scale is computed as scale=min(2, Log 2(width)−(Log 2(3*absInvAngle−2)−8));

When the scale parameter is a positive integer between 0 and 2, as the value of wL decreases to 0 with increasing y, the scale parameter determines the number of rows in the target block that are modified in the PDPC process. Since the maximum value of wL is 32, the number of rows undergoing PDPC is (3<<scale).

When the prediction direction is close to purely vertical (or purely horizontal for horizontal modes), depending on the block height (or width for horizontal modes), the scale parameter computed above can be a negative integer (i.e., less than 0). This implies that, for even 3 pixels in the last row (or the last column for horizontal modes) of the target block, not all the secondary reference samples are available. In this case, the gradient PDPC is enabled.

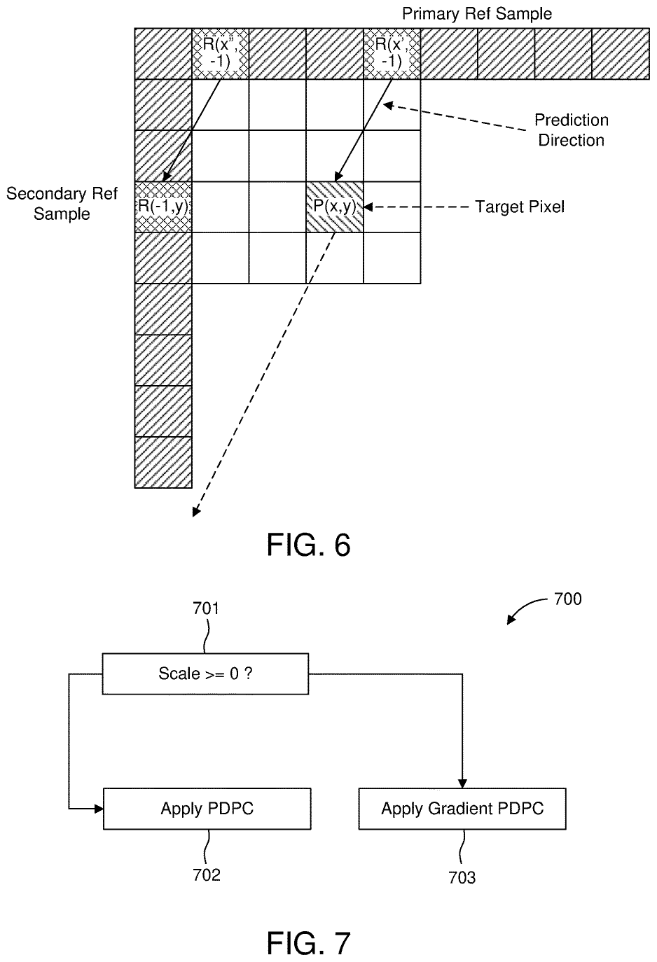

FIG. 7 illustrates a method 700 for determining whether which PDPC to apply to the target block. At 701, the scale parameter is determined as above:

$$scale = min ( 2 , Log 2 ( height ) - ( Log 2 ( 3 * absInvAngle - 2 ) - 8 ) ) for a vertical prediction direction$$

$$and$$

$$scale = min ( 2 , Log 2 ( width ) - ( Log 2 ( 3 * absInvAngle - 2 ) - 8 ) ) ; for a horizontal prediction direction .$$

At 701, if the scale parameter equals 0 or is positive, the process goes to 702, and normal PDPC is applied as described above, otherwise the process goes to 703 and gradient PDPC is applied as described below. When gradient PDPC is applied at 703, the scale parameter is recomputed as:

$$scale = ( Log 2 ( height ) + Log 2 ( width ) - 2 ) >> 2 ;$$

FIG. 6 illustrates an example of the gradient PDPC applied to a target block. For a target pixel at location (x,y), for a positive vertical direction, the reference sample R(−1, y) on the left reference array on the same row as the target pixel is used as the secondary reference sample. The gradient value is determined by finding the predictor sample R(x″, −1) for the secondary reference sample R(−1, y) in the prediction direction. The gradient is added to the first prediction P(x,y) at (x,y) with weighting:

$$P ( x , y ) = Clip ( P ( x , y ) + ( w {L}^{*} ( R ( - 1 , y ) - R ( x ” , - 1 ) ) + 32 ) >> 6 )$$

where R(x″,−1) denotes the predictor sample for the secondary reference sample at (−1,y), and wL is computed as wL=32>>(2*x>>scale) with the recomputed scale parameter.

The predictor sample is linearly interpolated whenever x″ does not pass through a reference sample index. The value is clipped to the dynamic range of the component as it is not guaranteed to lie in the range. The recomputed scale parameter has the minimum value 0 and maximum value 3 (for a maximum CU size of 128×128).

As described above, the number of columns undergoing gradient PDPC is (3<<scale), with the recomputed scale value. Notice that, for all the eligible pixels on any row of the target block, the secondary reference sample, and hence the determined gradient value, are the same. Therefore, they are determined outside the loop (unlike the normal PDPC) for pixels on a row.

For a positive horizontal direction, the process is analogous where the columns are replaced by rows, and the secondary reference samples are on the top reference array. The number of rows undergoing gradient PDPC is (3<<scale), with the recomputed scale value. Like for positive vertical directions, for all the eligible pixels on any column of the target block, the secondary reference sample, and hence the determined gradient value, are the same. Therefore, they are determined outside the loop (unlike the normal PDPC) for pixels on a column.

Some embodiments provide a method for improving intra prediction, and more particularly in the case of angular prediction direction. Some embodiments provide a method for unifying the normal PDPC and gradient PDPC applied for angular modes in intra prediction.

In an embodiment, the two PDPC process are combined together with binary weights so that either, but not both, of them is used at any instant. This leads to a simplification of the existing code but having the same result as the original code.

In another embodiment, the two PDPC are combined with variable weights where the weights are derived based on the prediction direction and block size. As the prediction direction gets closer to the purely vertical or purely horizontal directions, the PDPC varies gradually from the normal PDPC to the gradient PDPC with combinations of both of them in-between.

Position dependent intra prediction combination (PDPC) is included in the derivation of the TIMD modes. Therefore, any one of the embodiments described herein that applies to PDPC can also be used when applying PDPC in the derivation of the TIMD modes.

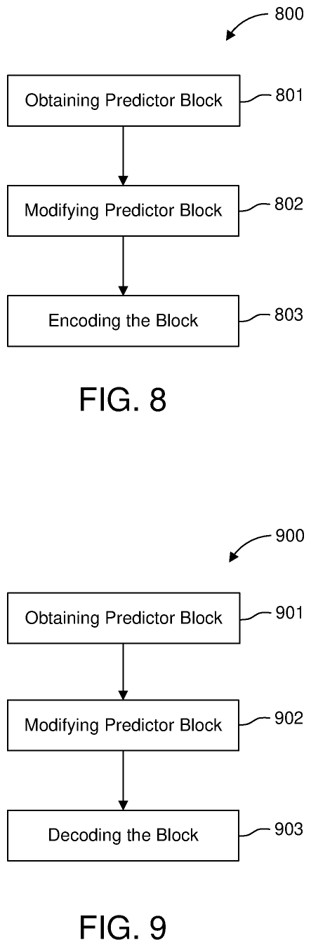

FIG. 8 illustrates an example of a method 800 for encoding a video according to an embodiment. At 801, a predictor block for a block of a video to encode is obtained based on an intra prediction mode that uses one or more primary reference samples. For that, for each pixel of the video block, a first prediction is obtained using the intra prediction mode.

Preferably, the intra prediction mode is a mode that uses an angular mode, and more particularly a positive horizontal direction or a positive vertical direction. The first prediction is obtained using one or more primary reference samples determined from the prediction direction in the primary reference sample array.

At 802, the predictor block is modified using for at least one pixel of the block, a weighted combination of values determined from at least two secondary reference samples. In some embodiments, the first prediction obtained at 801 for the at least one pixel is modified using a weighted combination of at least two gradients wherein the at least two gradients are determined using secondary reference samples. In an embodiment, one of the at least two secondary reference samples is obtained by extending the angular intra prediction mode towards the secondary reference array and the other of the at least two secondary reference samples is located in the secondary reference array in a same column or in a same row as the at least one pixel depending on whether the intra prediction mode is in a vertical or horizontal direction. In another embodiment, when the secondary reference sample obtained by extending the angular intra prediction mode towards the secondary reference array is not available for the at least one pixel, the weighted combination uses a pixel of the predictor block on a first column or row of the predictor block and on a same row or column as the at least one pixel and a secondary reference sample obtained for that pixel on the first column or row.

In some embodiments, the weighted combination is a position dependent pixel combination (PDPC) that uses for at least one pixel of the block, two secondary reference samples and another primary reference sample.

The at least two secondary reference samples are distinct and the other primary reference sample is obtained as the predictor of one of the at least two secondary reference samples according to the intra prediction mode. At 803, the video block is encoded using the modified predictor block. The encoding method 800 can be implemented in an intra prediction module of a video encoder, such as the one of encoder 200 of FIG. 2.

FIG. 9 illustrates an example of a method 900 for decoding a video according to an embodiment.

At 901, a predictor block for a block of a video to encode is obtained based on an intra prediction mode that uses one or more primary reference samples. For that, for each pixel of the video block, a first prediction is obtained using the intra prediction mode.

Preferably, the intra prediction mode is a mode that uses an angular mode, and more particularly a positive horizontal direction or a positive vertical direction. The first prediction is obtained using one or more primary reference samples determined from the prediction direction in the reference sample array.

At 902, the predictor block is modified using, for at least one pixel of the block, a weighted combination of values determined from at least two secondary reference samples. In some embodiments, the first prediction obtained at 901 for the at least one pixel is modified using a weighted combination of at least two gradients wherein the at least two gradients are determined using secondary reference samples. In an embodiment, one of the at least two secondary reference samples is obtained by extending the angular intra prediction mode towards the secondary reference array and the other of the at least two secondary reference samples is located in the secondary reference array in a same column or in a same row as the at least one pixel depending on whether the intra prediction mode is in a vertical or horizontal direction. In another embodiment, when the secondary reference sample obtained by extending the angular intra prediction mode towards the secondary reference array is not available for the at least one pixel, the weighted combination uses a pixel of the predictor block on a first column or row of the predictor block and on a same row or column as the at least one pixel and a secondary reference sample obtained for that pixel on the first column or row.

In some embodiments, the weighted combination is a position dependent pixel combination (PDPC) that uses for at least one pixel of the block, two secondary reference samples and another primary reference sample.

The at least two secondary reference samples are distinct and the other primary reference sample is obtained as the predictor of one of the at least two secondary reference samples according to the intra prediction mode.

At 903, the video block is encoded using the modified predictor block. The decoding method 900 can be implemented in an intra prediction module of a video decoder, such as the one of decoder 300 of FIG. 3.

Some embodiments for determining the weighted combination are described below.

In some embodiments, the weighted combination comprises a first term relating to a position dependent pixel combination that uses a first secondary reference sample determined based on the intra prediction mode, referred as normal PDPC or PDPC in the document and a second term relating to a gradient position dependent pixel combination (referred as gradient PDPC) that uses a second secondary reference sample located on a same row or column as a target pixel and a primary reference sample determined for the second secondary reference sample.

In a variant, modifying the predictor block comprises for the at least one pixel of the predictor block, modifying a prediction value for the at least one pixel using a weighted combination of the first term and the second term. In this embodiment, a first weight associated to the first term and a second weight associated to the second term are non-zero. This provides a modified prediction value for which both the PDPC and gradient PDPC contributes to the modifications.

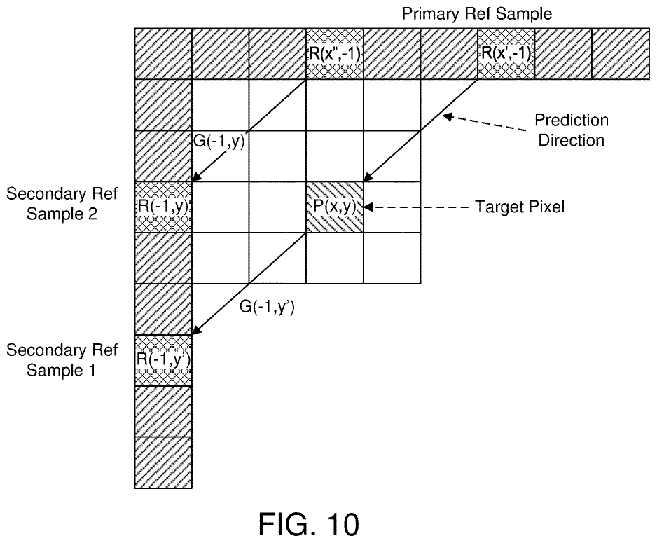

An embodiment of a unified PDPC is illustrated on FIG. 10.

For a given target pixel at (x,y), two secondary reference samples are considered: the secondary reference sample 1 which is determined in a similar manner as in the normal PDPC and the secondary reference sample 2 as in gradient PDPC. We compute the gradient at the secondary reference sample 2 as which is determined in a similar manner as in the gradient PDPC by determining its predictor sample at (x″, −1). The predicted value at (x,y) is modified as follows:

$$P ( x , y ) = Clip ( P ( x , y ) + ( wL * ( R ( - 1 , y ’ ) - P ( x , y ) ) + wL 1 * ( ( R ( - 1 , y ) - R ( x ” , - 1 ) ) - ( R ( - 1 , y ’ ) - P ( x , y ) ) ) + 32 ) >> 6 )$$

The weights wL and wL1 are determined as follows:

$$w L = 32 >> ( 2 * x >> scale )$$

$$wL 1 = wL >> ( 6 * bPdpc )$$

where the scale and the parameter bPdpc are determined as follows:

a parameter pdpcScale is first obtained as:

$$pdpcScale = min ( 2 , Log 2 ( height ) - ( Log 2 ( 3 * absInvAngle - 2 ) - 8 ) ) ;$$

Then, if the pdpcScale is 0 or above (If pdpcScale>=0) then the scale parameter is set to the pdpcscale determined above (scale=pdpcScale) and a flag bPdpc is set to 1 (bPdpc=1).

Otherwise (pdpcScle is below 0), the scale parameter is recomputed as

$$scale = ( Log 2 ( height ) + Log 2 ( width ) - 2 ) >> 2$$

$$et the flag bPdpc is set to 0 ( bPdpd = 0 ) .$$

Like the determination of the scale parameter, the determination of the flag bPdpc is done once per block.

As can be seen, in the first case (pdpcScale>=0), wL1=(wL>>6)=0 as the maximum value of wL is 32. Therefore, in this example, the unified PDPC is:

$$P ( x , y ) = Clip ( P ( x , y ) + ( wL * ( R ( - 1 , y ’ ) - P ( x , y ) ) + 32 ) >> 6 ) )$$

which is equivalent to the normal PDPC.

In the second case (pdpcScale<0), wL1=(wL>>0)=wL. And therefore, in this example, the unified PDPC is:

$$P ( x , y ) = Clip ( P ( x , y ) + ( wL * ( R ( - 1 , y ’ ) - P ( x , y ) ) + wL * ( ( R ( - 1 , y ) - R ( x ” , - 1 ) ) - ( R ( - 1 , y ’ ) - P ( x , y ) ) ) + 32 ) >> 6 ) = Clip ( P ( x , y ) + ( wL * ( R ( - 1 , y ) - R ( x ” , - 1 ) ) + 32 ) >> 6 ) ,$$

which is equivalent to the gradient PDPC.

The unified PDPC can be equivalently expressed as:

$$P ( x , y ) = Clip ( P ( x , y ) + ( ( wL * G ( - 1 , y ’ ) + wL 1 ⋆ ( G ( - 1 , y ) - G ( - 1 , y ’ ) ) + 32 ) >> 6 ) ) .$$

where G(−1,y) denotes the gradient computed at (−1,y) in the prediction direction.

In the case of a positive horizontal direction, the process remains the same where the columns are interchanged for rows and vice versa. The two secondary reference samples are on the top reference array and the predictor samples (primary reference samples) are on the left reference array. The weights wL and wL1 are computed as follows:

$$w L = 32 >> ( 2 * y >> scale )$$

$$wL 1 = wL >> ( 6 * bPdpc )$$

where the scale and the parameter bPdpc are computed as follows:

$$pdpcScale = min ( 2 , Log 2 ( width ) - ( Log 2 ( 3 * absInvAngle - 2 ) - 8 ) ) ;$$

If pdpcScale>=0, the scale parameter is set to pdpcScale and bPdpc is set to 1. Otherwise (pdpcScale>0), the scale parameter is determined as scale=(Log 2(height)+Log 2(width)−2)>>2 and bPdpc is set to 0.

In this example, the unified PDPC process is expressed as the following weighted combination:

$$P ( x , y ) = Clip ( P ( x , y ) + ( ( wL * G ( x ’ , - 1 ) + w L 1 * ( G ( x , - 1 ) - G ( x ’ , - 1 ) ) + 32 ) >> 6 ) ) .$$

where G(x,−1) denotes the gradient computed at (x,−1) in the prediction direction.

Such a unification results in identical results as in ECM 7.0 code for instance since in the weighted combination given above either the normal PDPC or the gradient PDPC contributes to the modification of the predicted value at one time.

In another embodiment, this constraint of removed such that both the normal PDPC or the gradient PDPC contribute to the modification of the predicted value. Their partial contribution varies depending on the prediction direction and block size.

In this embodiment, the parameter pdpcScale is determined as follows for positive vertical direction:

$$pdpcScale = max ( - 2 , min ( 2 , Log 2 ( height ) - ( Log 2 ( 3 * absInvAngle - 2 ) - 8 ) ) ) ;$$

The weights of the contribution of each PDPC are set based on the parameter pdpcScale.

When pdpcScale is 0 or above (If pdpcScale>=0), the scale parameter is set to pdpcScale and the weights are set as follows:

$$scale = pdpcScale ;$$

$$wL = 32 >> ( 2 * x >> scale )$$

$$wL 1 = wL >> ( 2 + 2 * scale )$$

The weighted combination is thus given by:

$$P ( x , y ) = Clip ( P ( x , y ) + ( ( wL * G ( - 1 , {y}^{′} ) + wL 1 ⋆ ( G ( - 1 , y ) - G ( - 1 , {y}^{′} ) ) + 32 ) >> 6 ) ) .$$

The gradient G(−1,y′) at (−1,y′) and gradient G(−1,y) at (−1,y) are determined in a similar manner as described above:

$$G ( - 1 , {y}^{′} ) = R ( - 1 , {y}^{′} ) - P ( x , y ) ;$$

$$G ( - 1 , y ) = R ( - 1 , y ) - R ( {x}^{″} , - 1 ) ;$$

When pdpcScale is 0 or above, for every eligible target pixel of the predictor block, the secondary reference samples 1 and 2 are available and therefore there is no difficulty in the above determination. In this case, the values of wL and wL1 are given in Table 2 below:

TABLE 2
Number of columns or rows processed in an embodiment of the
unified PDPC and the corresponding weights for predictions
along positive vertical directions when pdpcScale >=
0. wL = 32 >> (2*x >> scale) and wL1 = wL >> (2 + 2 * pdpcScale).

| | | wL(x) for x = | |
|---|---|---|---|
| scale | Num Cols (K) | 0, 1, . . . (K-1) | wL1(x) |
| 0 | 3 | 32, 8, 2 | 8, 2, 0 |
| 1 | 6 | 32, 16, 8, 4, 2, 1 | 2, 1, 0, 0, 0, 0 |
| 2 | 12 | 32, 32, 16, 16, 8, | 0, 0, 0, 0, 0, 0, |
| | | 8, 4, 4, 2, 2, 1, 1 | 0, 0, 0, 0, 0, 0 |

As can be seen, for scale value 2, the contribution of gradient PDPC is zero and it becomes equivalent to the normal PDPC; but for scale=0 and scale 1, the gradient PDPC is contributed up to two columns with higher contribution ratio in scale=0 than for scale=1.

The unified PDPC process provided herein enables for one or more pixels, to modify their predicted value using both the normal PDPC and the gradient PDPC. In other words, the unified PDPC process enables for one or more pixels to use more than one secondary reference sample to modify its predicted value when angular prediction mode is used.

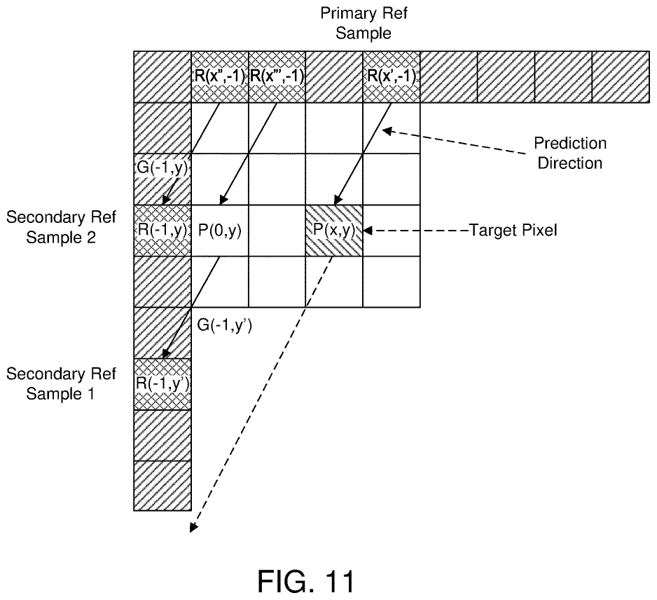

When the parameters pdpcScale is negative (pdpcScale<0), the secondary reference sample 1 is not available for all eligible target pixels. However, it is observed that, when the parameter pdpcScale is equal to −1, the secondary reference sample 1 is always available for the 1st column of target pixels. Therefore, the gradient at the secondary reference sample 1 that has been determined for the first column of target pixels is used in addition to the gradient as determined in gradient PDPC. This is illustrated in FIG. 11 which shows P(0,y) being a target pixel in the first column of the predictor block and the secondary reference sample 1 R(−1, y′) used for P(0,y) which is available.

If pdpcScale is negative (If pdpcScale<0), the scale parameter and weights are determined as follows:

$$scale = ( Log 2 ( height ) + Log 2 ( width ) - 2 ) >> 2 ;$$

$$wL = 32 >> ( 2 * x >> scale )$$

$$wL 1 = wL >> ( 2 - 2 * pdpcScale )$$

The weighted combination for modifying the predicted value for a pixel of the predictor block is given by:

$$P ( x , y ) = Clip ( P ( x , y ) + ( ( wL * G ( - 1 , y ) + wL 1 * ( G ( - 1 , {y}^{′} ) - G ( - 1 , y ) ) + 32 >> 6 ) ) .$$

The y-coordinate y′ of the secondary reference sample 1 is obtained as

$${y}^{′} = y + 1 + ( 2 \; 56 + absInvAngle * ( pdpcScale + 2 ) ) >> 9 ;$$

and the gradient G(−1,y′) is determined as G(−1, y′)=R(−1, y′)−P(0, y).

Unlike the previous case, here y′ is not a function of x, but is a fixed integer depending on the absInvAngle value. Thus, for a given row, the gradient G(−1,y′) can be pre-computed as the gradient G(−1,y). In this case, the values of wL and wL1 are given in Table 3 below:

TABLE 3
Number of columns or rows processed in proposed unified
PDPC and the corresponding weights for predictions along
positive vertical directions when pdpcScale < 0.

| | | wL(x) for x = | wL1(x) | wL1(x) |
|---|---|---|---|---|
| | Num Cols | 0, 1, . . . | (pdpcScale = | (pdpcScale <= |
| scale | (K) | (K-1) | −1) | −2) |
| 0 | 3 | 32, 8, 2 | 2, 0, 0 | 0,0,0 |
| 1 | 6 | 32, 16, 8, 4, 2, 1 | 2, 1, 0, 0, 0, 0 | 0, 0, 0, 0, 0, 0 |
| 2 | 12 | 32, 32, 16, 16, 8, | 2, 2, 1, 1, 0, 0, | 0, 0, 0, 0, 0, 0, |
| | | 8, 4, 4, 2, 2, 1, 1 | 0, 0, 0, 0, 0, 0 | 0, 0, 0, 0, 0, 0 |

$$wL = 32 >> ( 2 * x >> scale ) and wL 1 = wL >> ( 2 - 2 * pdpcScale ) .$$

Gradient at (−1,y′) is computed only once like the gradient at (−1,y) and is used for the target pixels at (x,y), x>=0.

As can be seen, for pdpcScale=−2 and less, the contribution of normal PDPC is zero and it becomes equivalent to the gradient PDPC.

In another embodiment, the original gradient can be replaced by a weighted combination of the two gradients outside of the loop, with the weights wL=32, and wL1=32>>4=2, for pdpcScale=−1 and wL1=32>>6=0 for pdpcScale=−2. In this embodiment, the resulting combined gradient value is used for modifying the values of the predictor block with weights wL as shown in the third column of Table 3, and the fourth and fifth columns for wL1(x) are not necessary.

In the embodiments described above, distinct weighted combinations are used depending on whether the parameter pdpcScale is positive or negative. In another variant, the above embodiments (pdpcScale>=0 and pdpcScale<0) can be combined in a single expression as:

$$P ( x , y ) = Clip ( P ( x , y ) + ( ( w 1 * G ( - 1 , {y}^{′} ) + w 2 * G ( - 1 , y ) + 32 ) >> 6 ) ) ,$$

where the weights w1 and w2 are derived as follows:

$$pdpcScale = max ( - 2 , min ( 2 , Log 2 ( height ) - ( Log 2 ( 3 * absInvAngle - 2 ) - 8 ) ) ) ;$$

If pdpcScale is positive or null (If pdpcScale>=0), the scale parameter is scale=pdpcScale, and the weights are as follows:

$$wL = 32 >> ( 2 * x >> scale )$$

$$wL 1 = wL >> ( 2 + 2 * pdpcScale )$$

$$w 1 = wL - wL 1 ;$$

$$w 2 = wL 1 ;$$

Otherwise (pdpcScale is negative), the scale parameter is set to scale=(Log 2(height)+Log 2(width)−2)>>2, and the weights are as follows:

$$wL = 32 >> ( 2 * x >> scale )$$

$$wL 1 = wL >> ( 2 - 2 * pdpcScale )$$

$$w 1 = wL 1 ;$$

$$w 2 = wL - wL 1 ;$$

This embodiment allows to have one single weighted combination for modifying the values of the predictor block. Only the weights are determined based the value of pdpcScale and depending on whether the prediction direction is vertical or horizontal.

In this embodiment, the weight wL1 is a fraction of wL and is derived using the parameter pdpcScale, which in turn depends on both the block size (height for vertical angles and width for horizontal angles) and the prediction angle. Alternatively, w1 can be derived in other ways; for example, it can be derived based on only the prediction angle as follows:

```
pdpcScale = min(2, Log2(height) − (Log2(3 * absInvAngle − 2) − 8));
gScale1 = 15 − Log2(3 * absInvAngle − 2);
gScale2 = max(0,Log2(3 * absInvAngle − 2) − 8);
If pdpcScale >= 0
  {scale = pdpcScale;
  wL = 32 >> (2*x >> scale)
  wL1 = wL >> gScale1
  w1 = wL − wL1;
  w2 = wL1;}
else
  {scale = (Log2(height) + Log2(width) − 2) >> 2;
  wL = 32 >> (2*x >> scale)
  wL1 = wL >> gScale2
  w1 = wL1;
  w2 = wL − wL1;}
```

The values of the parameters gScale1 and gScale2 depend only the absInvAngle, or equivalently on intraPredAngle corresponding to the prediction direction. The following Table 4 lists gScale1 and gScale2 values corresponding to intraPredAngle value:

TABLE 4
The values of scale parameters gScale1 and gScale2 as functions
of abs(intraPredAngle). A here denotes the intraPredAngle.

| Abs(A) | 1 | 2 | 3 | 4 | 6 | 8 | 10 | 12 | 14 | 16 | 18 | 20 | 23 | 26 | 29 | 32 |
|---|---|---|---|---|---|---|---|---|---|---|---|---|---|---|---|---|
| gScale1 | 1 | 2 | 3 | 3 | 4 | 4 | 4 | 5 | 5 | 5 | 5 | 5 | 5 | 6 | 6 | 6 |
| gScale2 | 7 | 6 | 5 | 5 | 4 | 4 | 4 | 3 | 3 | 3 | 3 | 3 | 3 | 2 | 2 | 2 |

| Abs(A) | 35 | 39 | 45 | 51 | 57 | 64 | 73 | 86 | 102 | 128 | 171 | 258 | 341 | 512 | 1024 |
|---|---|---|---|---|---|---|---|---|---|---|---|---|---|---|---|
| gScale1 | 6 | 6 | 6 | 7 | 7 | 7 | 7 | 7 | 8 | 8 | 8 | 9 | 9 | 10 | 11 |
| gScale2 | 2 | 2 | 2 | 1 | 1 | 1 | 1 | 1 | 0 | 0 | 0 | 0 | 0 | 0 | 0 |

Embodiments of the unified PDPC have been described above with a positive vertical direction. The unified PDPC is analogous for positive horizontal directions where the height and the width are interchanged and the rows and columns are interchanged.

In addition, embodiments of the unified PDPC are described herein for a video block included in an image of a video. The embodiments described herein can also apply in a similar manner to a block of an image in an image encoder or decoder.

Furthermore, in the above description, the wL value is used as in VVC and ECM. It can be replaced with any other decreasing function. The scale values used to derive wL1 are also examples. Instead of using as follows, for the case of pdpcScale>=0, wL1=wL>>(2+2*scale),

other functions can be used such as:

$$wL 1 = wL >> ( 2 + scale ) ,$$

$$wL 1 = wL >> ( 1 + 2 * scale ) ,$$

$$wL 1 = wL >> ( 1 + 3 * scale ) ,$$

which are all examples of increasing functions of scale. Similarly, for the case of pdpcScale<0, instead of using the following wL1=wL>>(2−2*pdpcScale), other decreasing functions can be used such as

$$wL 1 = wL >> ( 2 - pdpcScale ) ,$$

$$wL 1 = wL >> ( 1 - 2 * pdpcScale ) ,$$

$$wL 1 = wL >> ( 1 - 3 * pdpcScale ) .$$

In the proposed methods described above, the same interpolation methods as used in PDPC or gradient PDPC from VVC and ECM are used. That is, for the secondary reference sample 1, the nearest neighbor interpolation is used, and for the predictor of the secondary reference sample 2, the linear interpolation is used.

In other embodiments, higher order filters can be used such as a linear, or a 4-tap or a 6-tap cubic filter, for the secondary reference sample 1.

In another variant, depending on whether the primary reference samples use a smoothing filter or a cubic filter, a similar filter for the interpolation of the predictor for the secondary reference sample 2 can be used.

The unified PDPC described herein has been implemented with ECM 7.0. Table 5 shows the BD-rate performance. As can be seen, there is an overall BD-rate gain of about −0.01% for the Luma component. Sequences in Class F produce the best results with a gain of −0.04%. Note that coding efficiency is not the only advantage of the methods provided herein. Unification of PDPC and gradient PDPC also cleans the video decoding process design, by specifying a single method instead of the two initial switchable methods PDPC and gradient PDPC.

All Intra Main 10
Over ECM-7.0-IDG

| | Y | U | V | EncT | DecT |
|---|---|---|---|---|---|
| Class A1 | −0.02% | 0.03% | −0.04% | 101% | 101% |
| Class A2 | 0.00% | 0.04% | 0.05% | 101% | 101% |
| Class B | −0.01% | 0.05% | 0.02% | 96% | 95% |
| Class C | −0.02% | 0.01% | −0.03% | 100% | 101% |
| Class E | −0.01% | −0.07% | −0.02% | 101% | 97% |
| Overall | −0.01% | 0.02% | 0.00% | 99% | 98% |
| Class D | −0.01% | −0.29% | 0.03% | 102% | 108% |
| Class F | −0.04% | 0.10% | 0.15% | 101% | 97% |

In the following embodiments, it is assumed a video codec that includes PDPC in intra prediction such as a codec based on VVC standard, or ECM video compression exploratory model.

In an embodiment, the RD performance of the unified PDPC that enables contribution of normal PDPC and gradient PDPC described herein is compared with the implementation of either normal PDPC or gradient PDPC as done in VVC or ECM. The better method is chosen and is signaled to a decoder with an indicator.

In a variant, the performance of the unified PDPC that enables contribution of normal PDPC and gradient PDPC described herein is compared with the performance of either normal PDPC or gradient PDPC as done in VVC or ECM using a template as used for a template-based intra mode derivation (TIMD) of VVC. An example of such template is illustrated on FIG. 15 (a). For a positive angular mode, both PDPC (unified PDPC or VVC PDPC) approaches are tested with the template based on their SATD between the prediction and reconstruction of the template, and the better method is chosen for the video block to encode or decode. In this case, the chosen method can be signaled with an indicator, or the decoder can infer the same using a similar template.

Any of the embodiments described above can make use of the secondary reference sample 1 being interpolated using either linear interpolation, or a 4-tap or a 6-tap cubic filter instead of taking just the nearest neighbor sample.

Any of the embodiments described above can make use of the predictor for the secondary reference sample 2 being interpolated using either a 4-tap or a 6-tap cubic filter or a smoothing filter instead of the default linear interpolation. The cubic filter or the smoothing filter is chosen based on if the primary reference samples use a cubic filter or a smoothing filter, respectively, for interpolation.

ECM version 7 uses gradient PDPC only for the Luma component whereas the normal PDPC is used for both the Luma and chroma components. In another embodiment, the unified PDPC provided herein is used for both the Luma and chroma components.

In another embodiment, any one of the embodiments described above uses an activation of the unified PDPC provide herein that is signaled in a slice header of a picture that includes the video block to encode or decode or in a PPS header or in an SPS header.

As described above, following the initial prediction of a given block via a given intra prediction mode, if PDPC is allowed, the blending of a given predicted sample with the secondary reference sample accessed by PDPC often improves the quality of prediction provided that this secondary reference sample does not arise from the padding of an available reference sample located far from it. This is due to the likely small correlation between this padded secondary reference sample and the current original block sample to be predicted.

In a variant embodiment, for a given block, following its initial prediction via a given intra prediction mode, if PDPC is allowed, for each predicted sample whose secondary reference sample accessed by PDPC results from the padding of an available reference sample located far from it, PDPC is cancelled for this predicted sample.

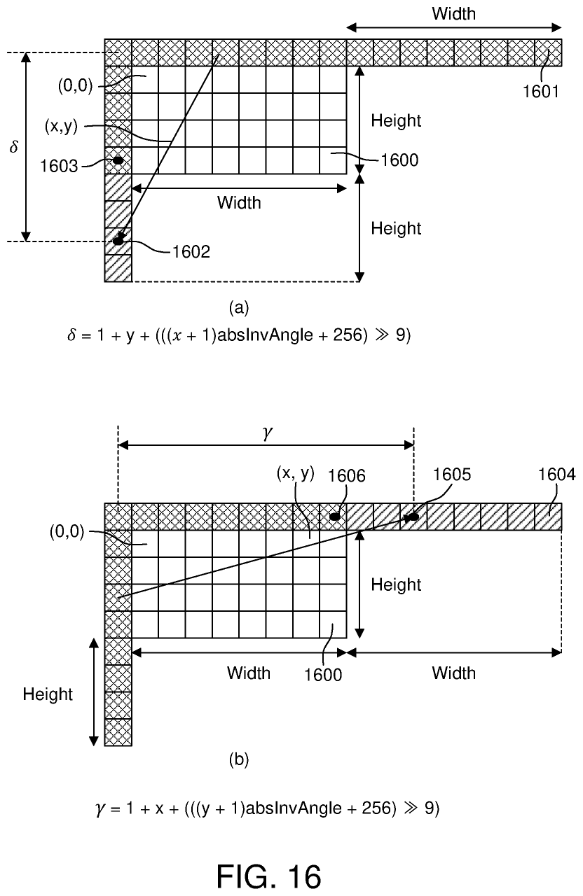

For instance, FIG. 16 shows two examples' illustrations of this variant embodiment in the case of a given block (shown with white squares) predicted via a directional intra prediction mode in ECM.

In FIG. 16 (a), following the initial prediction of the width×height block (1600) from its set (1601) of reference samples via the vertical positive intra prediction mode whose direction is represented by the bold arrow, PDPC applies. To perform the PDPC blending for the predicted sample at position (x, y), x∈ [symbol] 0, width−1 [symbol] , y∈ [symbol] 0, height−1 [symbol] , the secondary reference sample (1602) should be found using the direction represented by the bold arrow. In other words, the secondary reference sample of index δ=1+y+(((x+1)absInvAngle+256)>>9) in the secondary reference array should be accessed. absInvAngle denotes the inverse of the tangent of the mode angle scaled by 512, and integerized. The mode angle is defined with respect to the “reference” axis of the intra prediction mode, the “reference” axis being the vertical axis for a vertical intra prediction mode and the horizontal axis for a horizontal intra prediction mode. In FIG. 16 (a), the reference samples in dark gray are unavailable. In ECM, these unavailable samples are thus padded from the available reference sample (1603). However, when the unavailable reference sample is far from the sample used for padding, this can degrade efficiency of PDPC.

According to a variant of the embodiment described here, if the n bottommost reference samples are unavailable and δ≥δₗᵢₘᵢₜ, PDPC for the predicted sample at position (x,y) is cancelled. For instance, n=height. For instance, δₗᵢₘᵢₜ=height+1. In that case, the prediction of the sample provided by the primary reference sample is not modified by the secondary reference sample that is unavailable.

Other values for δₗᵢₘᵢₜ can also be considered. For instance, some of the padded reference samples (1602) that are closest to the reference sample used for padding (1603) can be used in the PDPC. For instance, δₗᵢₘᵢₜ can be set to height+2 or height+3 . . . .

In FIG. 16 (b), following the initial prediction of the width×height block (1600) from its set (1604) of reference samples via the horizontal positive intra prediction mode whose direction is represented by the bold arrow, PDPC applies. To perform the PDPC blending for the predicted sample at position (x, y), x∈ [symbol] 0, width−1 [symbol] , y∈ [symbol] 0, height−1 [symbol] , the secondary reference sample (1605) should be found using the direction represented by the bold arrow. In other words, the secondary reference sample of index y=1+x+(((y+1)absInvAngle+256)>>9) in the secondary reference array should be accessed. In FIG. 16 (b), the reference samples in dark gray are unavailable, i.e. padded from the available reference sample (1606). According to another variant of the embodiment described here, if the p rightmost reference samples are unavailable and γ≤γₗᵢₘᵢₜ, PDPC for the predicted sample at position (x,y) is cancelled. For instance, p=width. For instance, γₗᵢₘᵢₜ=width+1. As for the vertical case, other values for γₗᵢₘᵢₜ can be used.

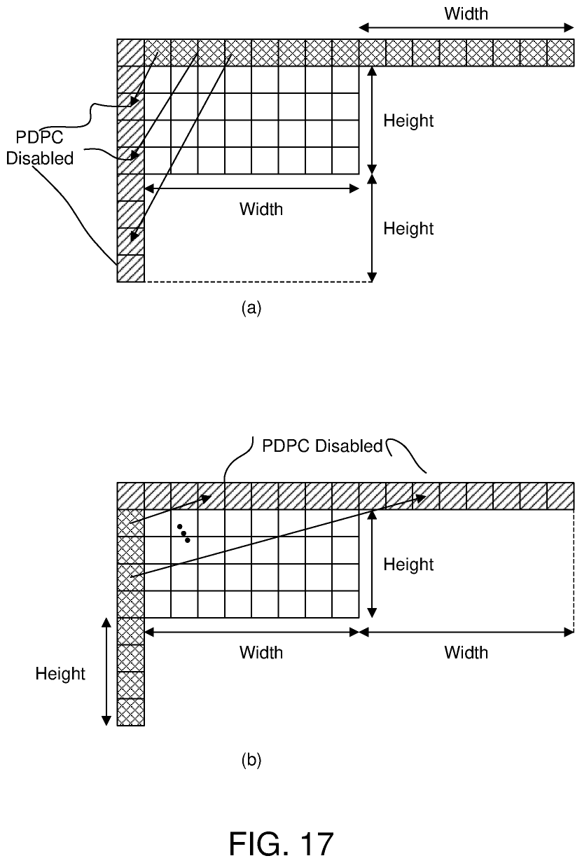

In another embodiment, rather than disabling the PDPC on a sample-basis, enabling or disabling PDPC can be considered on a block basis. For instance, if the current block does not have at least one neighboring available block on its left side, then the PDPC with vertical angular modes is disabled. Similarly, if the current block does not have at least one neighboring available block above it, then the PDPC with horizontal angular modes is disabled. FIG. 17 provides illustrations of this variant embodiment. In FIG. 17 (a), the reference samples of the current width×height block in bright gray are available whereas those in dark gray are unavailable. As the current block has no neighboring available block on its left side, for any prediction of the current block via a vertical angular mode, PDPC is disabled.

In FIG. 17 (b), the reference samples of the current width×height block in bright gray are available whereas those in dark gray are unavailable. As the current block has no neighboring available block above it, for any prediction of the current block via a horizontal angular mode, PDPC is disabled.

In the embodiments described above, a neighboring block can be unavailable for example because it does not exist, for instance the current block is at a border of the picture or in another example because the neighboring block cannot be used for the current block, for instance the neighboring block and the current block are encoded in separate tiles that are encoded independently from each other.

The variant embodiments described above can be used in a same manner for all coding modes using the PDPC tool, or distinct variants of applying the PDPC can be used depending on the coding mode.

In a variant embodiment, the above disabling of PDPC can be done only at the decoder (including the decoder at the encoder). Then, the encoder can use the PDPC with eligible angular modes irrespective of the availability of the above and left neighboring blocks.

As described above, for a given block, following the initial prediction of this block via a given intra prediction mode, if PDPC is allowed, PDPC enables to remove some discontinuities between the predicted samples and the reference samples around the boundaries of the predicted block. Therefore, around the boundaries of the predicted block, the closer to the reference samples the predicted samples are, the better PDPC works.

However, for a given block using TIMD, during the derivation step of TIMD, during the prediction of the template of this block from the reference samples of the template via a given intra prediction mode, the template design features a hole between the template and its reference samples, thus reducing the effectiveness of PDPC. Such a hole is for instance illustrated on FIG. 15 as the white square between the portion 1501 and the portion 1502 of the template of the block 1503.

If this hole is eliminated, PDPC can become more effective. Following the same principle, if this hole is removed, gradient PDPC can become more effective as well.

Also note that, as a beneficial side effect of the elimination of this hole, the template samples often get more correlated to the reference samples of the template, thus enhancing the quality of the whole template prediction, not only PDPC.

According to another aspect of the present disclosure, a method for encoding or decoding a video block is provided wherein a template-based intra prediction mode derivation (TIMD) is adapted. More particularly, in some embodiments, for a video block using TIMD, during the derivation step of TIMD, instead of defining a set of reference samples of the template, this set being common to the above and left portions of the template, each portion of the template owns a different set of reference samples. This allows to remove the hole between the template and its reference samples. The reference samples used to predict the template are closer to the template and thus prediction is improved. In addition, this adaptation of the set of reference samples allows to keep the same size of the template using in TIMD in ECM, thus the same prediction unit can be re-used. For instance, the two parts of the template can have a size which is a power of 2.

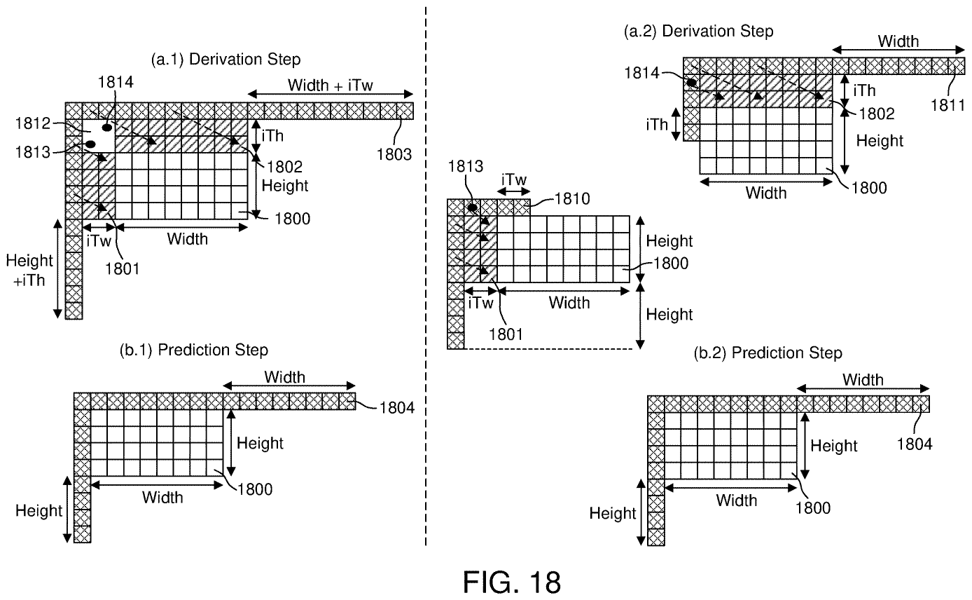

FIG. 18 (a.1) and (a.2) show a current block to be predicted (1800), its template, and the reference samples of the template during the derivation step of TIMD. FIG. 18 (a.1) illustrates the template (1801 and 1802) and its reference samples (1803) as used in ECM while FIG. 18(a.2) illustrates an embodiment provided herein of the adaptation of the sets of reference samples (1810, 1811) for the template (1801 and 1802) for TIMD. In FIG. 18 (a.1) and (a.2), both the above and left portions of the template of the current block (1800) are available.

In FIG. 18 (a.1), for a given width×height block (1800) during the derivation step of TIMD, for a given intra prediction mode to be tested on the template of (1800), which comprises its iTw×height left portion (1801) and its width×iTh above portion (1802), some reference samples in the set (1803) of 2(width+iTw)+2(height+iTh)+1 reference samples of the template are used to predict both (1801) and (1802). (1812) denotes the iTw×iTh hole between the template and its reference samples that exists in the prediction of the template used in ECM.

In FIG. 18 (a.2), for a given intra prediction mode to be tested on the template of (1800), some reference samples in the set (1810) of reference samples of the left template portion (1801) are used to predict the left template portion (1801) whereas some reference samples in the set (1811) of reference samples of the above template portion (1802) are used to predict the above template portion (1802).

Unlike FIG. 18 (a.1), FIG. 18 (a.2) does not contain any hole between the template of (1800) and its reference samples.

In FIG. 18 (a.1) and (a.2), to provide an example of which reference samples are used to predict the template of (1800), the black dotted arrows indicate the direction of extrapolation of the reference samples of the template into the template for the directional intra prediction mode of index 48. Expressed differently, for a given sample to be predicted in a template portion, the tail of the arrow crossing this sample locates the reference sample at the center of the directional interpolation filter for computing the prediction of this template sample.

This example reveals that the change of set of reference samples of the template of (1800) from FIG. 18 (a.1) to FIG. 18 (a.2) modifies the template prediction. For instance, in FIG. 18 (a.2), during the prediction of (1801) from (1810), the reference sample (1813) is accessed. But, in FIG. 18 (a.1), (1813) is not involved in the prediction of (1801). Note that a black-filled dot at the end of a marker like (1813) indicates that the marker labels a single pixel instead of a set of pixels with shared color.

Similarly, in FIG. 18 (a.2), during the prediction of (1802) from (1811), the reference sample (1814) is accessed. But, in FIG. 18 (a.1), (1814) is not involved in the prediction of (1802).

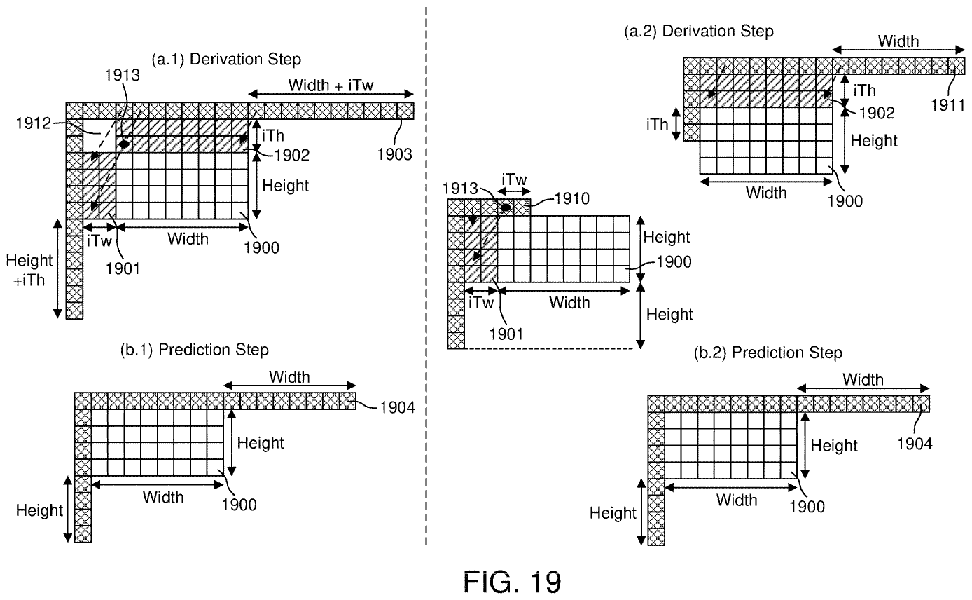

As another example, FIG. 19 copies FIG. 18, except that the intra prediction mode of index 112 replaces that of index 48.

In FIG. 19 (a.2), during the prediction of the left portion (1901) of the template of the block (1900) from the set (1910) of reference samples, the reference sample (1913) is accessed. But, in FIG. 19 (a.1), (1913) is not involved in the prediction of (1901).

Note that, in TIMD in ECM-7.0, as twice more directional intra prediction modes than in VVC span the range of directions from “bottom-left to top-right” to “top-right to bottom-left”, the index of a directional intra prediction mode belongs to [12, 1301].

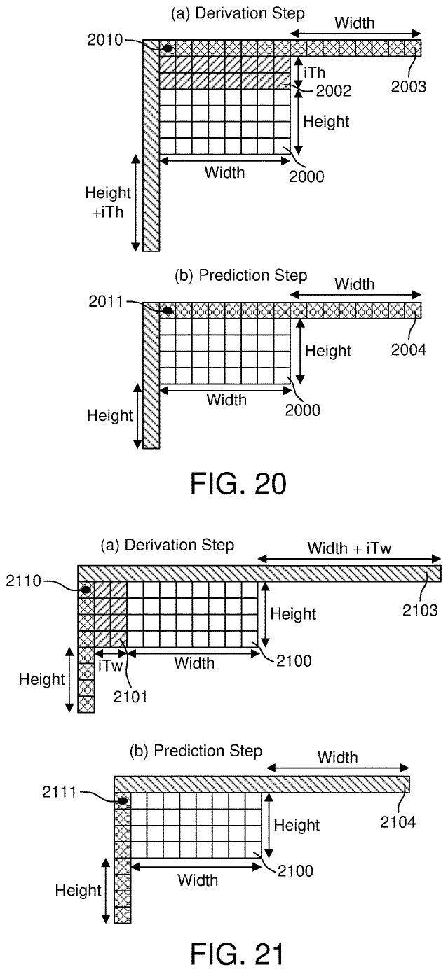

FIG. 20 (a) presents an embodiment wherein only the above portion (2002) of the template of a current block (2000) is available. The set (2003) of reference samples of the template during the derivation step of TIMD is completed with the reference samples colored in black. Since these reference samples are not available, they are generated by padding from the reference sample (2010).

FIG. 21 (a) presents an embodiment wherein only the left portion (2101) of the template of a current block (2100) is available. The set (2103) of reference samples of the template during the derivation step of TIMD is completed with the reference samples colored in black. Since these reference samples are not available, they are generated by padding from the reference sample (2110).

As shown in FIG. 20 (a) and FIG. 21 (a), during the derivation step of TIMD, the design of the reference samples of the template of the current block in ECM and that in the variant embodiment described with these figures correspond to the same design when only one of the two template portions is available.

FIG. 18 (b.1) and (b.2), FIG. 19 (b.1) and (b.2), FIG. 20 (b), and FIG. 21 (b) show that, once the derivation step of TIMD has returned the primary and secondary TIMD modes, during the prediction of the current block (1800, 1900, 2000, 2100), the reference samples used for predicting the current block share the same design in ECM and in the embodiment described above.

Note that, for (1803) in FIG. 18 (a.1), (1810) and (1811) in FIG. 18 (a.2), (1903) in FIG. 19 (a.1), (1910) and (1911) in FIG. 19 (a.2), (2003) in FIG. 20, and (2103) in FIG. 21, the shown relationship between the pair {size of the current block, size of its template} and the extension of the set of reference samples of the template towards the right-hand side may be adapted depending on the evolution of TIMD. Similarly, the shown relationship between the pair {size of the current block, size of its template} and the extension of the set of reference samples of the template towards the bottom may also be adapted depending on the evolution of TIMD.

For instance, from ECM-7.0 to ECM-8.0, the set of reference samples of the template has been extended by factor 4 to the right-hand side and bottom due to TIMD testing more wide-angle intra prediction modes from ECM-8.0. This extension may straightforwardly apply to this variant embodiment.

In a variant of the embodiment of the TIMD with the adapted sets of reference samples of the template described above in relation with FIG. 18-21, the TIMD follows the same rule defining the wide-angle intra prediction modes as in the TIMD used in ECM. More specifically, in ECM, for a given width×height block using TIMD, during the derivation step of TIMD, for a given intra prediction mode to be tested on the template of this block, the potential conversion of this intra prediction mode into its wide-angle version depends on width and height exclusively. Similarly, in this variant of the embodiment provided herein, in the case of TIMD with the adapted sets of reference samples of the template, for the width×height block using TIMD, during the derivation step of TIMD, the potential conversion of the intra prediction mode into its wide-angle version follows the same rule based on width and height of the current block.

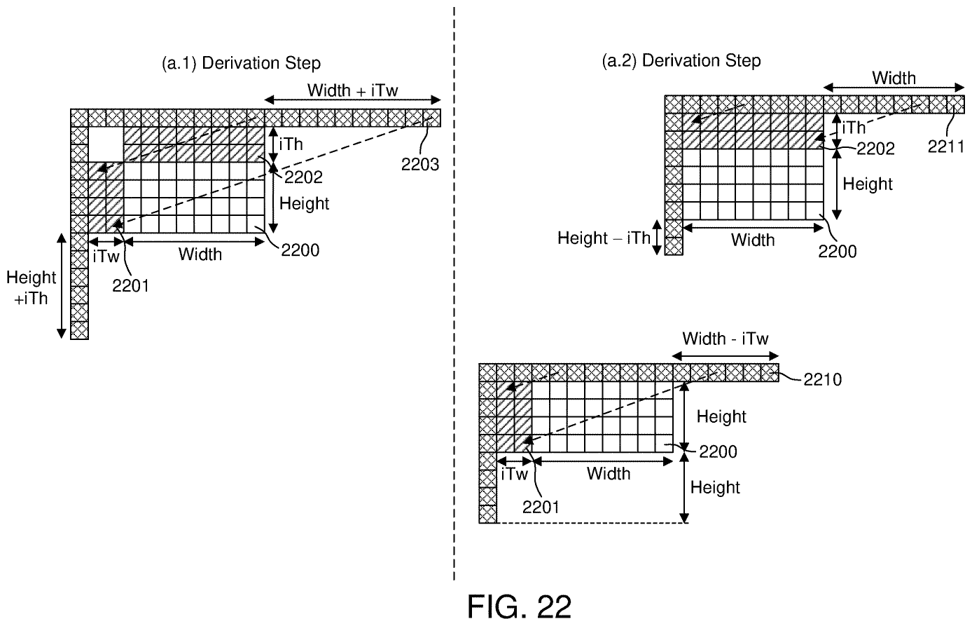

FIG. 22 (a.1) presents an example of TIMD as used in ECM for a given width×height block (2200), during the derivation step of TIMD. In this example, the prediction of the template including its iTw×height left portion 2201) and its width×iTh above portion (2202) from its set (2203) of 2(width+iTw)+2(height+iTh)+1 reference samples of the template is done via the intra prediction mode of index 12. In this example, as width=8 and height=4, before the template prediction, according to the wide-angle conversion rule, the intra prediction mode of index 12 is converted into the wide-angle mode of index 141.

FIG. 22 (a.2) depicts an example of the TIMD as provided herein in an embodiment, for a given width×height block (2200) using TIMD with the adapted sets of reference samples of the template, during the derivation step of TIMD. In this example, the prediction of the iTw×height left template portion (2201) from its set (2210) of reference samples and the prediction of the width×iTh above template portion (2202) from its set (2211) of reference samples is done via the intra prediction mode of index 12. Again, as width=8 and height=4, before the predictions of these two template portions (2201 and 2202), the intra prediction mode of index 12 is converted into the wide-angle mode of index 141. In FIG. 22 (a.1) and (a.2), the black dotted arrows show the direction of the wide-angle mode of index 141.

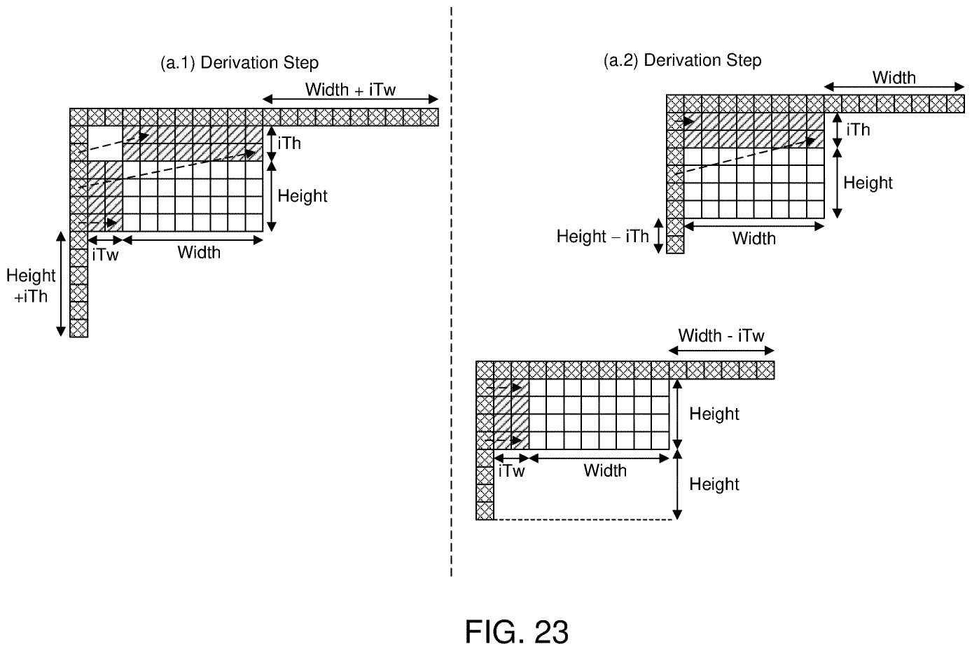

To illustrate with another example, FIG. 23 (a.1) copies FIG. 22 (a.1) and FIG. 23 (a.2) copies FIG. 22 (a.2), except that the intra prediction mode of index 13 replaces that of index 12. In FIG. 23 (a.1) and (a.2), as width=8 and height=4, the intra prediction mode of index 13 does not undergo any wide-angle conversion.

In a variant of the embodiment above, for a given block using TIMD with the adapted sets of reference samples of the template described herein, during the derivation step of TIMD, each of the two sets of reference samples of template portions is extended to the right-hand side and/or bottom such that the prediction of each of the two template portions is feasible. In other words, the sets of reference samples are extended when needed depending on the intra prediction mode that is tested. If an extended part of the set of reference samples of a template portion includes unavailable pixels, padding as in VVC/ECM is used to fill out the extended part.

For instance, in FIG. 22 (a.2) and FIG. 23 (a.2), the sets of reference samples (2210) includes 2 width reference samples above and on the above-right side of the left portion of the template (2201), making the prediction of the left part of the template (2201) always possible with the embodiment described above. Likewise, the sets of reference samples (2211) comprises 2 height reference samples on the left side and below-left side of the top part of the template (2202), making the prediction of the top part of the template (2202) always manageable with the embodiment described above.

Note that the examples of extensions in FIG. 22 (a.2) and FIG. 23 (a.2) rely on the TIMD template shapes as defined in ECM. This means that,

if width≤8, then iTw=2, otherwise iTw=4,

if height≤8, then iTh=2, otherwise iTh=4.

Other extensions are also possible, for example if the TIMD template shapes are changed to ensure that the prediction of (2201) from (2210) and the prediction of (2202) from (2211) are always feasible for the tested intra prediction modes.

In a variant embodiment, instead of reusing the wide-angle rule as it is used for TIMD in ECM, it is provided herein a variant wherein the wide-angle rule is modified and is based on the size of the portion of the template to be predicted.

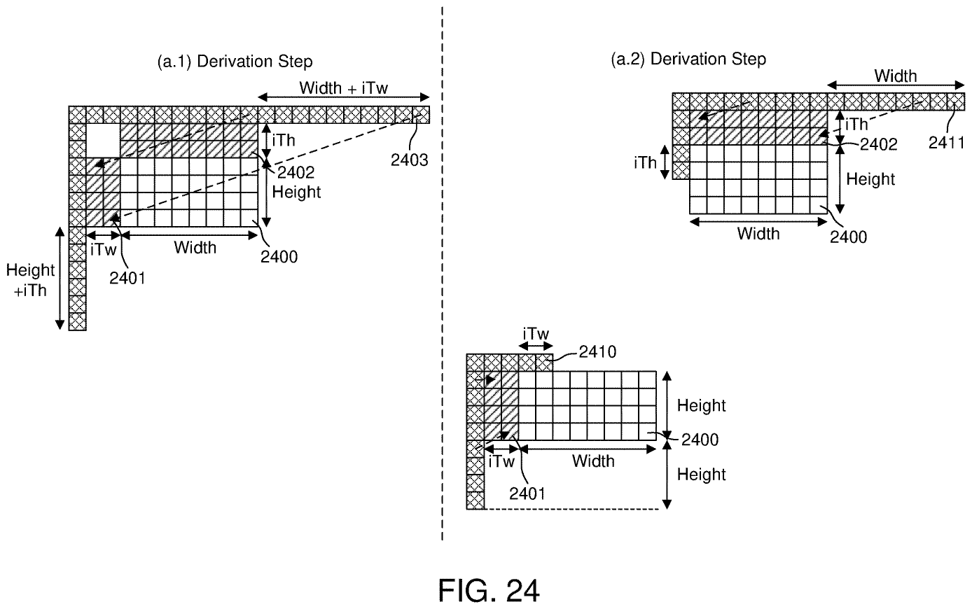

FIG. 24 (a.1) illustrates an example of the derivation step of TIMD as used in ECM, for a given width×height block (2400). In this example, the prediction of the template (2401, 2402) of the block (2400) from the set (2403) of reference samples of the template is done via the intra prediction mode of index 12, as in FIG. 22 (a.1). As width=8 and height=4, before the template prediction, according to the wide-angle conversion rule as defined in ECM, the intra prediction mode of index 12 is converted into the wide-angle mode of index 141.

FIG. 24 (a.2) presents an example of the derivation step of TIMD according to an embodiment with the adapted sets of reference samples, for a given width×height block (2400). In this example, the prediction of the iTw×height left template portion (2401) from its set (2410) of reference samples and the prediction of the width×iTh above template portion (2402) from its set (2411) of reference samples is done via the intra prediction mode of index 12.

According to the present embodiment, as iTw=2 and height=4, before the prediction of (2401), no wide-angle conversion applies to the intra prediction mode of index 12. But, as width=8 and iTh=2, before the prediction of (2402), the intra prediction mode of index 12 is converted into the wide-angle mode of index 141. Therefore, in this embodiment, the wide-angle conversion rule is applied based on the size of the template portion that is to be predicted.

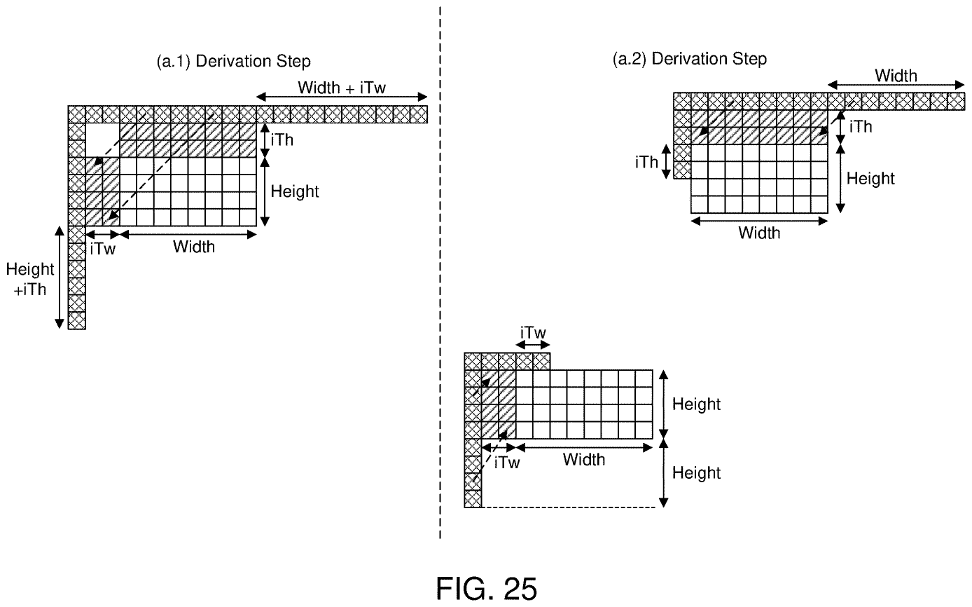

To illustrate with another example, FIG. 25 (a.1) copies FIG. 24 (a.1) and FIG. 25 (a.2) copies FIG. 24 (a.2), wherein the intra prediction mode of index 130 in FIG. 25 replaces that of index 12 used in FIG. 24. In FIG. 25 (a.1), as width=8 and height=4, the intra prediction mode of index 130 does not undergo any wide-angle conversion. In FIG. 25 (a.2), as iTw=2 and height=4, before the prediction of the left portion of the template of the current block, the intra prediction mode of index 130 is converted into the wide-angle mode of index 1. As width=8 and iTh=2, before the prediction of the above portion of the template of the current block, no wide-angle conversion applies to the intra prediction mode of index 130.

Note that, in FIG. 24 (a.2) and FIG. 25 (a.2), for each of the two portions of the template of the block, the shown extension of the set of reference samples of the template portion to the right-hand side and bottom is a simple example working for the prediction via any intra prediction mode within this variant embodiment. This shown extension may be modified without impacting the purpose of the current variant embodiment, i.e. the wide-angle rule based on the size of the template portion to be predicted.

In ECM, the wide-angle rule does not convert a directional intra prediction mode into the intra prediction mode of exact opposite direction. To fix this, in a variant embodiment, the wide-angle rule relies on the size of the portion of the template to be predicted and this wide-angle rule always converts a directional intra prediction mode into the intra prediction mode of exact opposite direction.

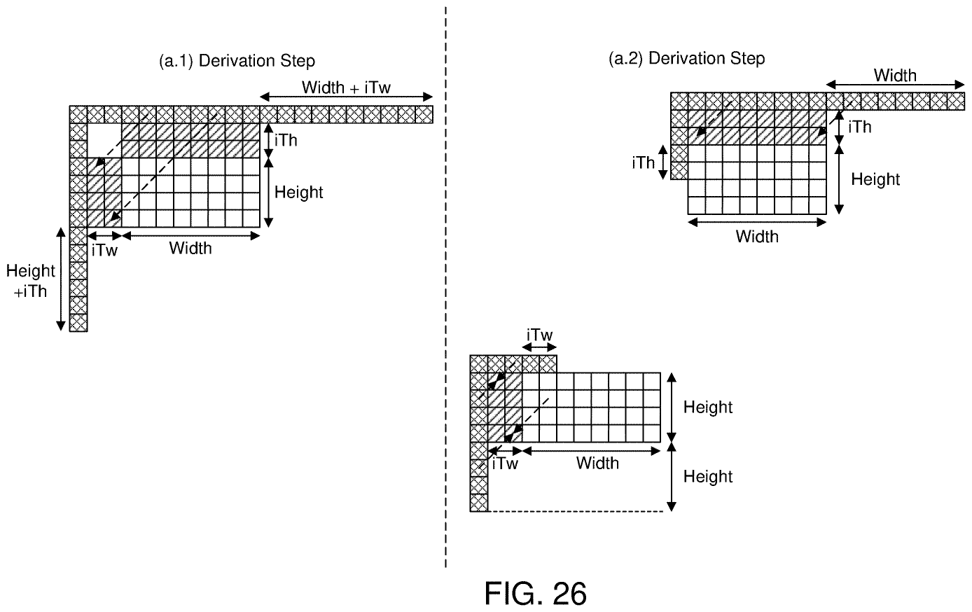

FIG. 26 adapts FIG. 25 to the current variant embodiment. Unlike in FIG. 25 (a.2), in FIG. 26 (a.2), as iTw=2 and height=4, before the prediction of the left portion of the template of the current block, the intra prediction mode of index 130 is converted into the intra prediction mode of index 2. This is because the intra prediction mode of index 130 and that of index 2 have exact opposite directions. In FIG. 26 (a.2), for the prediction of the left portion of the template of the current block, the gray dotted arrow indicates the direction of the intra prediction mode of index 130. The black dotted arrow shows the direction of the intra prediction mode of index 2.

Any of the above embodiments regarding TIMD with the adapted sets of reference samples of the template can be integrated into the process of a TIMD derivation process implemented in a video codec, for instance the ECM.

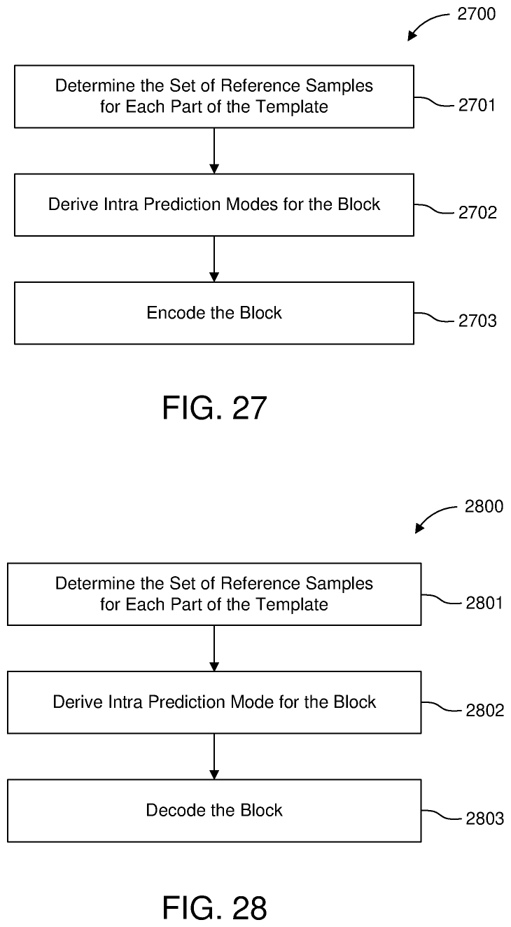

For instance, FIG. 27 illustrates an example of a method 2700 for encoding a video block using TIMD according to any one of the embodiments described herein. At 2701, the sets of reference samples for each part of the template are determined according to any one of the embodiments described herein in relation with FIG. 18-26. Depending on the variants described above that is used, the set of reference samples can be extended on the right-hand side and/or bottom-left of the left or above part of the template, as described in relation with FIG. 22-23.

At 2702, one or more intra prediction modes are derived based on the template of the block using the intra prediction mode derivation process of TIMD with the sets of reference samples for the left and above template portions determined at 2701. Depending on the variants described above that is used, the intra prediction mode that are evaluated in this derivation process can undergo wide-angle conversion if needed, as described in relation with FIG. 22-26.

At 2703, the video block is encoded based on the prediction obtained from the one or more intra prediction modes obtained at 2702.

FIG. 28 illustrates an example of a method 2800 for decoding a video block using TIMD according to any one of the embodiments described herein. At 2801, the sets of reference samples for each part of the template are determined according to any one of the embodiments described herein in relation with FIG. 18-26. The same embodiment used at the encoder shall be used on the decoder side. At 2802, one or more intra prediction modes are derived based on the template of the block using the intra prediction mode derivation process of TIMD with the sets of reference samples for the left and above template portions determined at 2801. The derivation process is similar as the one done on the encoder side. At 2803, the video block is reconstructed based on the prediction obtained from the one or more intra prediction modes obtained at 2802.

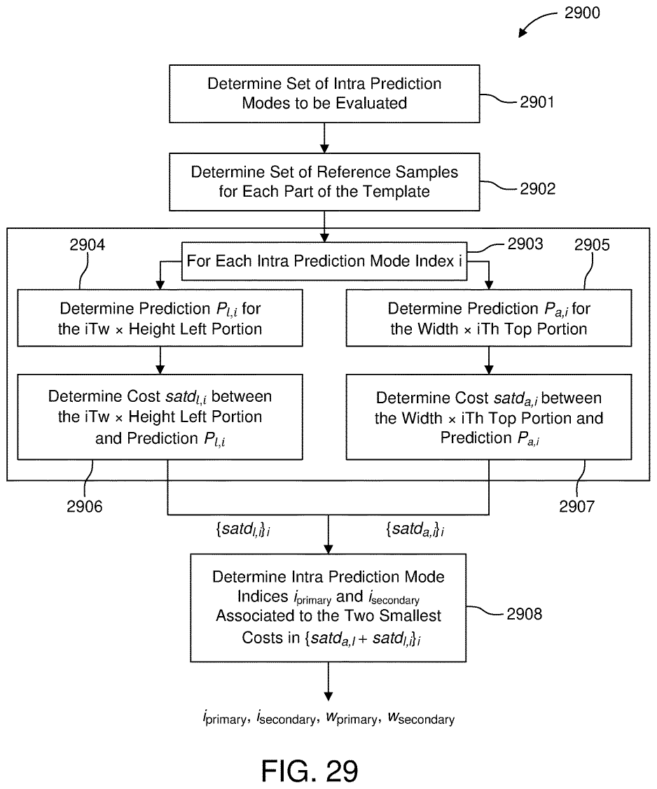

FIG. 29 illustrates an example of a workflow of the derivation (2900) step of TIMD with the adapted sets of reference samples of the template according to the embodiment illustrated in FIG. 18 a.2 or 19 a.2. The following steps are performed for a current block 1800 to be encoded or decoded.

At 2901, the set of intra prediction modes to be evaluated is determined. For instance, the set of intra prediction modes can be obtained from a list of Most Probable Modes (MPMs) of the current width×height block (1800). This list can be supplemented with intra prediction modes DC_IDX (for DC mode), VER_IDX, and HOR_IDX (vertical and horizontal modes) if these indices do not already appear in the list. At 2902, the set of reference samples for each part of the template (left and top parts) are determined. The left portion (1801) of the template having a size iTw×height uses the set (1810) of reference samples. The top portion (1802) of the template having a size width×iTh uses the set (1811) of reference samples. These sets of reference samples are extracted from the current channel, e.g. luminance channel for TIMD used by the current luminance block.

At 2903, a loop is done on the set of intra prediction modes to be evaluated on the template. For each intra prediction mode index i in the list collected at (2901), the process proceeds to steps (2904 and 2906) for the left portion of template and (2905 and 2907) for the top portion of the template.

At 2904, the prediction P_{l,i} of the left part (1801) of the template is determined from the set of reference samples (1810) via the mode index i. At 2906, the SATD satd_{l,i} between the left part (1801) of the template and the prediction P_{l,i} is calculated.

At 2905, the prediction P_{a,i} of top part (1802) of the template is determined from the set of reference samples (1811) via the mode index i. At 2907, the SATD satd_{a,i} between the top part (1802) of the template and the prediction P_{a,i} is calculated.

Once all intra prediction modes of the set have been evaluated, at (2908), one or more intra prediction mode indices are determined based on the costs evaluated in 2906 and 2907. For instance, the two smallest values in the set {satd_{a,i}+sat_{l,i}}ᵢ give the index i_{primary} of the primary TIMD mode and the index i_{secondary} of the secondary TIMD mode.

Besides, two blending weights w_{primary} and w_{secondary} are determined from satdᵢ_{_{primary}}=satd_{a,i}_{_{primary}}+satd_{l,i}_{_{primary}} and satdᵢ_{_{secondary}}=satd_{a,i}_{_{secondary}}+satd_{l,i}_{_{secondary}} respectively. The prediction step of the current block 1800 (step b.2 in FIG. 18) is done using the i_{primary} and i_{secondary} that are used to obtain two predictions of the current block (1800). The predictions for the current block (1800) are obtained using the reference samples (1804) defined for the current block (1800). These two predictions are blended using w_{primary} and w_{secondary}, yielding the final prediction of the current block (1800).

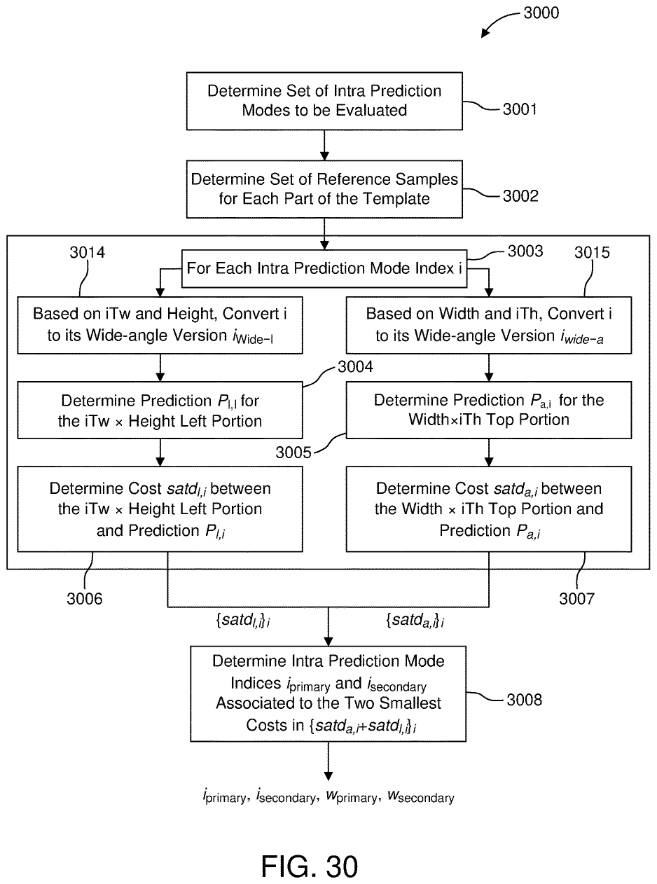

FIG. 30 illustrates another example of a workflow of the derivation (3000) step of TIMD with the adapted sets of reference samples of the template for a variant of the embodiment illustrated in FIG. 24 (a.2). The workflow is not limited to this embodiment, a similar workflow can be applied to the other embodiments illustrated through FIG. 18-26.

At (3001), a set of intra prediction modes to be evaluated by the TIMD is obtained for a current block to predict, the block (2400) having a size of width×height.

For instance, the set of intra prediction modes can be obtained from a list of Most Probable Modes (MPMs) of the current width×height block (2400). This list can be supplemented with intra prediction modes DC_IDX, VER_IDX, and HOR_IDX if these indices do not already appear in it.

At (3002), the set (2410) of reference samples of the iTw×height left portion (2401) of the template of the block (2400) and the set (2411) of reference samples of the width×iTh above portion (2402) of the template of the block (2400) are extracted from the current channel.

At 3003, a loop is done on the set of intra prediction modes to be evaluated on the template. For each intra prediction mode index i in the list collected at (3001), the process proceeds to steps (3014, 3004 and 3006) for the left portion of template and (3015, 3005 and 3007) for the top portion of the template.

At 3014, the parameters for predicting the left part (2401) of the template are derived. Depending on the variants used and the angle of the intra prediction mode, it is determined whether the intra prediction mode index i has to be converted into its associated wide-angle mode index i_{wide-l} depending on iTw and height. If so, the intra prediction mode index i is converted into its associated wide-angle mode index i_{wide-l}.

If the workflow 3000 is implemented using the variant illustrated with FIG. 22-23, at 3014, the conversion is based on the width and height of the current block.

At 3004, the prediction P_{l,i} of (2401) is determined from the set of reference samples (2410) via the mode index i or the mode of index_{wide-l} if converted at 3014. At 3006, the SATD satd_{l,i} between (2401) and P_{l,i} is calculated.

At 3015, the parameters for predicting the top part of the template (2402) are derived, which comprises if needed the conversion of i into its associated wide-angle mode index i_{wide-a} depending on width and iTh. If the workflow 3000 is implemented using the variant illustrated with FIG. 22-23, at 3015, the conversion is based on the width and height of the current block.

At 3005, the prediction P_{a,i} of (2402) is computed from its set of reference samples (2411) via the mode index i or the mode of index i_{wide-a} if converted.

At 3007, the SATD satd_{a,i} between (2402) and P_{a,i} is calculated.

Once all intra prediction modes of the set have been evaluated, at 3008, one or more intra prediction mode indices are determined based on the costs evaluated in 3006 and 3007. For instance, the two smallest values in the set {satd_{a,i}+satd_{l,i}}ᵢ give the index i_{primary} of the primary TIMD mode and the index i_{secondary} of the secondary TIMD mode.

Besides, two blending weights w_{primary} and w_{secondary} are computed from satdᵢ_{_{primary}}=satd_{a,i}_{_{primary}}+satd_{l,i}_{_{primary}} and satdᵢ_{_{secondary}}=satd_{a,i}_{_{secondary}}+satd_{l,i}_{_{secondary}} respectively. During the prediction step of the current block (2400), i_{primary} and i_{secondary} are used to obtain two predictions of the current block (2400). These two predictions are blended using w_{primary} and w_{secondary}, yielding the final prediction of the current block (2400).

In FIG. 29 and FIG. 30, the order of steps inside the workflow 2900 or 3000 of the derivation step of TIMD with the adapted sets of reference samples of the template serves as example only. Some steps can be swapped without affecting the process of the TIMD derivation. For instance, in FIG. 29 (2901) and (2902) can be swapped.

In ECM, e.g. ECM-8.0, the derivation step of TIMD is part of many template-based coding tools. For instance, the derivation step of TIMD occurs in Intra Block Copy (IBC), Geometric Partition Mode (GPM), and Combined Intra Inter Prediction (CIIP).

In a variant embodiment, the regular derivation step of TIMD in ECM is replaced by the derivation step of TIMD with the adapted sets of reference samples of the template as described in any one of the embodiments provided herein, for one or more of template-based coding tools that involve the derivation step of TIMD.

In another variant embodiment, the regular derivation step of TIMD in ECM is replaced by the derivation step of TIMD with the adapted sets of reference samples of the template as described in any one of the embodiments provided herein, for all the template-based coding tools involving the derivation step of TIMD.

In a variant, any one of the embodiments provided herein relating to the adaptation of the sets of reference samples of the template can be combined with any one of the embodiments provided herein relating to the PDPC tool. As the PDPC is used in the TIMD derivation and prediction processes, any one of the embodiments described herein for the PDPC can replace the PDPC used in the TIMD processes.

For instance, for the embodiments described in relation with FIG. 8-11 and FIGS. 16 and 17, the predictor block that is obtained at 801 and 901, is a predictor block obtained for a template of the video block in a template-based intra prediction mode derivation. In some variants, the at least two secondary reference samples used in the PDPC process for modifying the predictor block are located in a reference array determined for the template, the reference array comprising one or more reconstructed samples located on a row just above the template or on a column just to the left of the template or both. In some variants, in the PDPC process, the template comprising a first part located above the video block and a second part located to the left of the video block, the at least two secondary reference samples used for modifying the predictor block obtained for one of the first part or the second part are located in the other part of the first part and the second part.

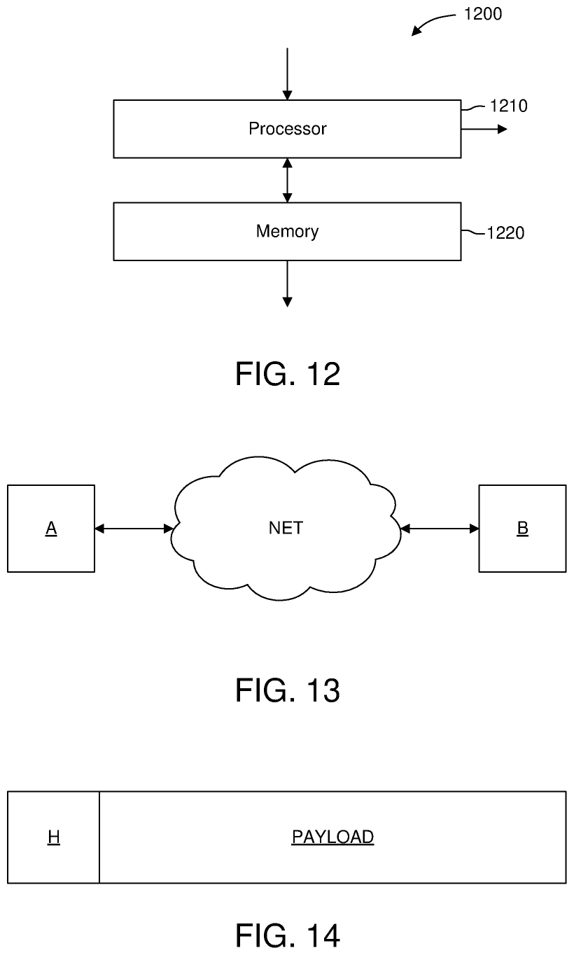

FIG. 12 illustrates a block diagram of a system within which aspects of the present embodiments may be implemented, according to another embodiment. FIG. 12 shows one embodiment of an apparatus 1200 for encoding or decoding a video according to any one of the embodiments described herein. The apparatus comprises Processor 1210 and can be interconnected to a memory 1220 through at least one port. Both Processor 1210 and memory 1220 can also have one or more additional interconnections to external connections.

Processor 1220 is also configured to obtain a predictor block for a video block based on an angular intra prediction mode that uses at least one primary reference sample, modify the predictor block using a position dependent pixel combination that uses for at least one pixel, a weighted combination of values determined from at least two secondary reference samples, and encode or decode the video block based at least on the modified predictor block, using any one of the embodiments described herein. For instance, the processor 1220 is configured using a computer program product comprising code instructions that implements any one of embodiments described herein.

In an embodiment, illustrated in FIG. 13, in a transmission context between two remote devices A and B over a communication network NET, the device A comprises a processor in relation with memory RAM and ROM which are configured to implement a method for encoding a video, as described with FIG. 1-11 or FIG. 15-30 and the device B comprises a processor in relation with memory RAM and ROM which are configured to implement a method for decoding a video as described in relation with FIG. 1-11 or FIG. 15-30. In accordance with an example, the network is a broadcast network, adapted to broadcast/transmit a coded video from device A to decoding devices including the device B.

FIG. 14 shows an example of the syntax of a signal transmitted over a packet-based transmission protocol. Each transmitted packet P comprises a header H and a payload PAYLOAD. In some embodiments, the payload PAYLOAD may comprise video data according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image or video data.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding.

Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method, comprising:
obtaining a predictor block for a video block based on an angular intra prediction mode;
determining a scale value for the predictor block based on a size of the video block and an angle of a prediction direction of the angular intra prediction mode;
modifying the predictor block using, for at least one pixel of the predictor block, a weighted combination of a first gradient value obtained from a position dependent pixel combination (PDPC) and of a second gradient value obtained from a gradient PDPC, wherein weights associated to the first gradient value and to the second gradient value in the weighted combination depend on the scale value and a position of the at least one pixel in the predictor block; and
encoding the video block based at least on the modified predictor block.

2. An apparatus, comprising one or more processors, wherein the one or more processors are operable to
obtain a predictor block for a video block based on an angular intra prediction mode;
determine a scale value for the predictor block based on a size of the video block and an angle of a prediction direction of the angular intra prediction mode;
modify the predictor block using, for at least one pixel of the predictor block, a weighted combination of a first gradient value obtained from a position dependent pixel combination (PDPC) and of a second gradient value obtained from a gradient PDPC, wherein weights associated to the first gradient value and to the second gradient value in the weighted combination depend on the scale value and a position of the at least one pixel in the predictor block; and
encode the video block based at least on the modified predictor block.

3. A method, comprising:
obtaining a predictor block for a video block based on an angular intra prediction mode;
determining a scale value for the predictor block based on a size of the video block and an angle of a prediction direction of the angular intra prediction mode;
modifying the predictor block using, for at least one pixel of the predictor block, a weighted combination of a first gradient value obtained from a position dependent pixel combination (PDPC) and of a second gradient value obtained from a gradient PDPC, wherein weights associated to the first gradient value and to the second gradient value in the weighted combination depend on the scale value and a position of the at least one pixel in the predictor block; and
decoding the video block based at least on the modified predictor block.

4. An apparatus, comprising one or more processors, wherein the one or more processors are operable to:
obtain a predictor block for a video block based on an angular intra prediction mode;
determine a scale value for the predictor block based on a size of the video block and an angle of a prediction direction of the angular intra prediction mode;
modify the predictor block using, for at least one pixel of the predictor block, a weighted combination of a first gradient value obtained from a position dependent pixel combination (PDPC) and of a second gradient value obtained from a gradient PDPC, wherein weights associated to the first gradient value and to the second gradient value in the weighted combination depend on the scale value and a position of the at least one pixel in the predictor block; and
decode the video block based at least on the modified predictor block.

5. (canceled)

6. The method of claim 3 wherein the first gradient value is obtained as a difference between a value of a first secondary reference sample and a value in the predictor block of the at least one pixel, the first secondary reference sample being obtained by extending the angular intra prediction mode from a position of the at least one pixel towards a secondary reference array.

7. The method of claim 3 wherein the second gradient value is obtained as a difference between a value of a second secondary reference sample and a value of a primary reference sample, the second secondary reference sample being located in a secondary reference array in a same column or in a same row as the at least one pixel depending on whether the angular intra prediction mode is in a vertical or horizontal direction and the primary reference sample being in a primary reference array used for obtaining the predictor block, the primary reference sample being obtained by extending the angular intra prediction mode from a position of the second secondary reference sample towards the primary reference array.

8-23. (canceled)

24. The method of claim 3 wherein responsive to a determination that a neighboring block of the video block that is used for determining the first gradient value or the second gradient value is not available, the predictor block is not modified.

25. (canceled)

26. A non-transitory computer readable medium storing executable program instructions to cause a computer executing the program instructions to perform a method according to claim 3.

27-28. (canceled)

29. The apparatus of claim 4 comprising:
at least one of (i) an antenna configured to receive or transmit a signal, the signal including data representative of the video block, (ii) a band limiter configured to limit the signal to a band of frequencies that includes the data representative of the video block, or (iii) a display configured to display the video block.

30. (canceled)

31. The method of claim 6, wherein responsive to a determination that the first secondary reference sample is not available, the first gradient value is determined as a difference between a value of a second primary reference sample and a value of a first pixel in the predictor block, the first pixel in the predictor block being located on a same row as the at least one pixel and in a first column of the predictor block or located on a same column as the at least one pixel and on a first row of the predictor block, the second primary reference sample being in a primary reference array used for obtaining the predictor block, the second primary reference sample being obtained by extending the angular intra prediction mode from a position of the first pixel towards the primary reference array.

32. The method of claim 3, wherein for a scale value being −2 or lower than −2, a weight associated to the first gradient value is 0.

33. The method of claim 3, wherein for a scale value being 2 or above, a weight associated to the second gradient value is 0.

34. The method of claim 3, wherein, for a scale value being positive or null, a weight associated with the second gradient value is derived from a weight associated with the first gradient value and an increasing function of scale.

35. The method of claim 3, wherein, for a scale value being negative, a weight associated with the first gradient value is derived from a weight associated with the second gradient value and a decreasing function of scale.

36. The apparatus of claim 4,
wherein the first gradient value is obtained as a difference between a value of a first secondary reference sample and a value in the predictor block of the at least one pixel, the first secondary reference sample being obtained by extending the angular intra prediction mode from a position of the at least one pixel towards a secondary reference array, and
wherein the second gradient value is obtained as a difference between a value of a second secondary reference sample and a value of a primary reference sample, the second secondary reference sample being located in a secondary reference array in a same column or in a same row as the at least one pixel depending on whether the angular intra prediction mode is in a vertical or horizontal direction and the primary reference sample being in a primary reference array used for obtaining the predictor block, the primary reference sample being obtained by extending the angular intra prediction mode from a position of the second secondary reference sample towards the primary reference array.

37. The apparatus of claim 36, wherein responsive to a determination that the first secondary reference sample is not available, the first gradient value is determined as a difference between a value of a second primary reference sample and a value of a first pixel in the predictor block, the first pixel in the predictor block being located on a same row as the at least one pixel and on a first column of the predictor block or located on a same column as the at least one pixel and in a first row of the predictor block, the second primary reference sample being in a primary reference array used for obtaining the predictor block, the second primary reference sample being obtained by extending the angular intra prediction mode from a position of the first pixel towards the primary reference array.

38. The apparatus of claim 4, wherein responsive to a determination that the scale value is negative, the first gradient value is determined as a difference between a value of a second primary reference sample and a value of a first pixel in the predictor block, the first pixel in the predictor block being located on a same row as the at least one pixel and in a first column of the predictor block or located on a same column as the at least one pixel and on a first row of the predictor block, the second primary reference sample being in a primary reference array used for obtaining the predictor block, the second primary reference sample being obtained by extending the angular intra prediction mode from a position of the first pixel towards the primary reference array.

39. The apparatus of claim 4,
wherein for a scale value being −2 or lower than −2, a weight associated to the first gradient value is 0, or
wherein for a scale value being 2 or above, a weight associated to the second gradient value is 0.

40. The apparatus of claim 4, wherein, for a scale value being positive or null, a weight associated with the second gradient value is derived from a weight associated with the first gradient value and an increasing function of scale.

41. The apparatus of claim 4, wherein, for a scale value being negative, a weight associated with the first gradient value is derived from a weight associated with the second gradient value and a decreasing function of scale.
